(19) United States
(12) Patent Application Publication
(10) Pub. No.: US 2014/0370367 A1
(43) Pub. Date: Dec. 18, 2014

(54) STRUCTURE OF BATTERY UNIT

(71) Applicant: DENSO CORPORATION, Kariya-city (JP)

(72) Inventors: Hiroaki HIGUCHI, Kariya-shi (JP); Hidehiro KINOSHITA, Nagoya (JP)

(73) Assignee: DENSO CORPORATION, Kariya-city (JP)

(21) Appl. No.: 14/288,843

(22) Filed: May 28, 2014

(30) Foreign Application Priority Data
Jun. 18, 2013 (JP) 2013-127378

(51) Int. Cl. H01M 2/20

(52) U.S. Cl. CPC H01M 2/206
USPC 429/158

(57) ABSTRACT

A battery unit is provided which includes a battery made of a stack of a plurality of cells each of which is equipped with electrode tabs serving as a positive terminal and a negative terminal. The electrode tabs each have a bent portion which lies between a body of the cell and a joint of the electrode tab to a bus bar. The bent portion is so geometrically shaped as to function as a stress absorber to minimize a mechanical stress which arises from oscillation of or thermal shock on the battery.

### CROSS REFERENCE TO RELATED DOCUMENT

The present application claims the benefit of priority of Japanese Patent Application No. 2013-127378 filed on Jun. 18, 2013, the disclosure of which is incorporated herein by reference.

### BACKGROUND OF THE INVENTION

1. Technical Field of the Invention

The present invention relates generally to a battery unit which includes a storage battery equipped with a stack of electrochemical cells for vehicles such as automobiles.

2. Background Art

Storage batteries have been put into practical use which are equipped with a plurality of electrochemical cells. Each of the cells has electrode tabs (i.e., a positive electrode tab and a negative electrode tab). The electrode tabs of each of the cells are joined to bus bars. The joints are made using, for example, ultrasonic welding techniques. This type of ultrasonic welding is disclosed in, for example, Japanese Patent First Publication No. 2004-114136. Specifically, this publication teaches a ultrasonic welding machine which holds the positive and negative electrode tabs of adjacent two of the cells between shaped surfaces of an anvil and a ultrasonic horn and vibrate the shaped surface of the ultrasonic horn parallel to that of the anvil to make joints of the positive and negative electrode tabs.

In the case where the battery is mounted in an automotive vehicle, the battery is usually subjected to mechanical repetitive oscillations. The oscillation of the battery results in physical load on the joints of the electrode tabs and the bus bars, which may lead to the breakage of the joints. Particularly, in the case where a battery assembly made up of a plurality of cells and a bus bar holder with a plurality of bus bars are secured in a storage casing, the battery assembly and the bus bar holder vibrate independently from each other in response to oscillation of the storage casing, thereby exerting stress on the joints of the electrode tabs to the bus bars and resulting in instability of the joints.

### SUMMARY

It is therefore an object of this disclosure to provide an improved structure of a battery unit which is designed to secure the stability of joints of electrode tabs of cells to bus bars.

According to one aspect of this disclosure, there is provided a battery unit which may be employed with automatic vehicles. The battery unit comprises: (a) a battery which includes a stack of a plurality of laminated-type cells each of which is equipped with electrode tabs serving as a positive terminal and a negative terminal, respectively, each of the electrode tabs having a base end leading to a body of a corresponding one of the cells; (b) a bus bar holder equipped with a plurality of bus bars joined to the electrode tabs of the cells; (c) a storage casing in which the battery and the bus bar holder are mounted in the storage casing; (d) first electrode tabs that are the electrode tabs of every adjacent two of the cells, the first electrode tabs having portions which are laid on one another and joined to the bus bars, respectively; and (e) second electrode tabs that are the electrode tabs of the cells. Each of the second electrode tabs has a portion joined to one of the bus bars without being connected to any of the electrode tabs.

Each of the first and second electrode tabs includes opposed major surfaces and has a bent portion which is shaped to protrude in at least one of opposite directions traversing the opposed major surfaces and is located between the base end and a joint to the bus bar.

Specifically, the battery is equipped with the stack of the cells and the battery holder secured firmly in the storage casing. The electrode tabs of each of the cells are joined to the bus bars. This type of battery usually encounters the drawback in that the oscillation of the storage case results in stress exerted on the joints of the electrode tabs to the bus bars, which may lead to breakage of the joints. In order to avoid this problem, the electrode tabs are designed to have the bent portions functioning as stress absorbers to minimize the stress acting on the joints. This ensures the stability in joining of the electrode tabs to the bus bars.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a perspective view which shows an overall structure of a battery unit according to an embodiment;

FIG. 2 is a transverse sectional view, as taken long the line II-II in FIG. 1;

FIG. 3 is an exploded perspective view which shows essential parts of the battery unit of FIG. 1;

FIG. 4 is a perspective view which illustrates a base on which an assembled battery module is mounted;

FIG. 5 is a plane view of FIG. 4;

FIG. 6 is a bottom view which illustrates a cover fastened to the base of FIG. 5;

FIG. 7 is a perspective view which illustrates an intermediate case disposed between the base of FIG. 4 and the cover of FIG. 6;

FIG. 8(a) is a plane view of the intermediate case of FIG. 7;

FIG. 8(b) is a bottom view of the intermediate case of FIG. 7;

FIG. 9 is a vertical sectional view, as taken along the line IX-IX in FIG. 8(a);

FIG. 10 is an enlarged perspective view of a water damage sensor;

FIG. 11 is a vertical section view of a base and an intermediate case of a storage case which illustrates a vertical location of the water damage sensor of FIG. 10;

FIG. 12 is a perspective view which shows an assembled battery module mounted in the battery unit of FIG. 1;

FIG. 13 is an exploded perspective view which illustrates an assembled battery module;

FIG. 14 is an exploded perspective view which illustrates an assembled battery module;

FIG. 15 is a plane view of an assembled battery module;

FIG. 16 is a sectional view, as taken along the line XVI-XVI of FIG. 15;

FIG. 17 is a side view which illustrates joints of electrode tabs of cells of an assembled battery module;

FIG. 18 is a partially enlarged view of FIG. 17;

FIG. 19 is a plane view which illustrates an assembled battery module mounted on a base of a storage case of the battery unit of FIG. 1;

FIG. 20(a) is a partial side view which illustrates how to ultrasonic-weld a stack of electrode tabs and a bus bar of an assembled battery module;

FIG. 20(b) is a partial side view which illustrates how to ultrasonic-weld an electrode tab and a bus bar of an assembled battery module;

FIG. 21 is a perspective view which illustrates a control board installed in the battery unit of FIG. 1;

FIG. 22 is a plane view which illustrates the control board of FIG. 21 mounted on a base of a storage case;

FIG. 23 is a circuit diagram which shows an electric structure of a power supply system; and

FIG. 24 is a side view which shows a modified form of the electrode tabs of FIG. 17;

FIG. 25 is an exploded view of FIG. 24;

FIG. 26 is a second modified form of the electrode tabs of FIG. 17;

FIG. 27(a) is a plane view which illustrates a modified form of an assembled battery module; and

FIG. 27(b) is a plane view which illustrates another modified form of an assembled battery module.

### DESCRIPTION OF THE PREFERRED EMBODIMENTS

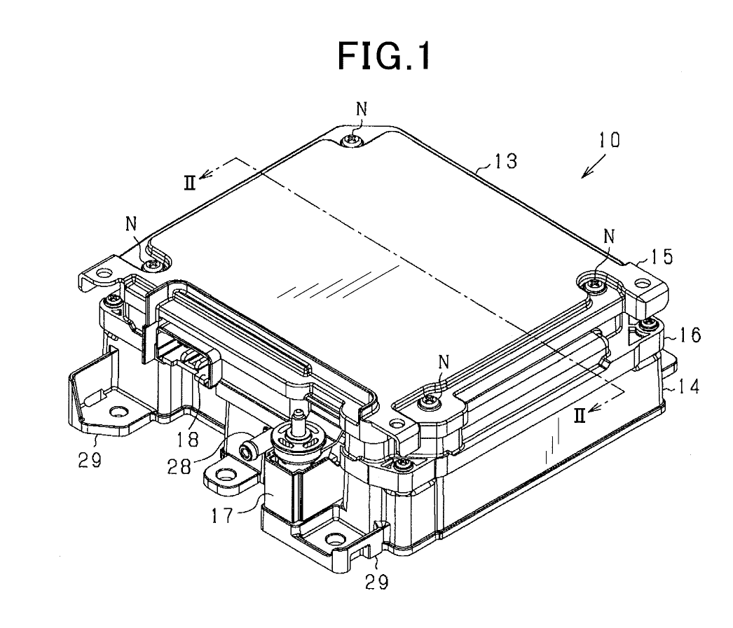

Referring to the drawings, wherein like reference numbers refer to like parts in several views, particularly to FIGS. 1 to 3, there is shown a battery unit 10 which is used, as an example, with a power supply system installed in an automotive vehicle equipped with an internal combustion engine, an electronic control unit (ECU) working to control operations of the engine or other electric devices, an electric generator (also called an alternator) which is driven by the engine to generate electricity, and an electric storage device which is charged by electric power produced by the generator. The electric storage device includes a lead acid battery and lithium-ion battery. The battery unit 10, as will be described below, is designed as the lithium-ion battery.

The overall structure of the battery unit 10 will be described below with reference to FIGS. 1 to 3. A vertical direction of the battery unit 10, as referred to in the following discussion, is based on orientation of the battery unit 10 placed, as illustrated in FIG. 1, on a horizontal plane for the sake of convenience.

The battery unit 10 consists essentially of an assembled battery module 11, a control board 12, and a storage case 13. The assembled battery module 11 is made up of a stack of laminated-type cells each covered with a laminate film. The control board 12 works as a controller to control charging or discharging of the assembled battery module 11. The storage case 13 has the assembled battery module 11 and the control board 12 installed therein and is made up of a base 14, a cover 15, and an intermediate case 16. The base 14 is fixed at a place where the battery unit 10 is installed. The cover 15 is arranged above the base 14. The intermediate case 16 is joined between the base 14 and the cover 15 as a side shell defining a portion of a side wall of the storage case 13. The assembled battery module 11 and the control board 12 are laid to overlap each other vertically. Specifically, the control board 12 is disposed above the assembled battery module 11. The assembled battery module 11 and the control board 12 are fixed to the base 14. The cover 15 and the intermediate case 16 are also fastened to the base 14.

The battery unit 10 is equipped with a terminal block 17 for electric connection with an external lead-acid battery or an electric generator and an electric connector 18 for electric connection with the ECU mounted in the vehicle. The electric connector 18 is also joinable to other electric loads to which the power is to be supplied from the battery unit 10. The terminal block 17 and the connector 18 are, as can be seen in FIG. 1, partially exposed outside the battery unit 10.

The structure of the battery unit 10 will be described below in detail.

### Base 14 of Storage Case 13

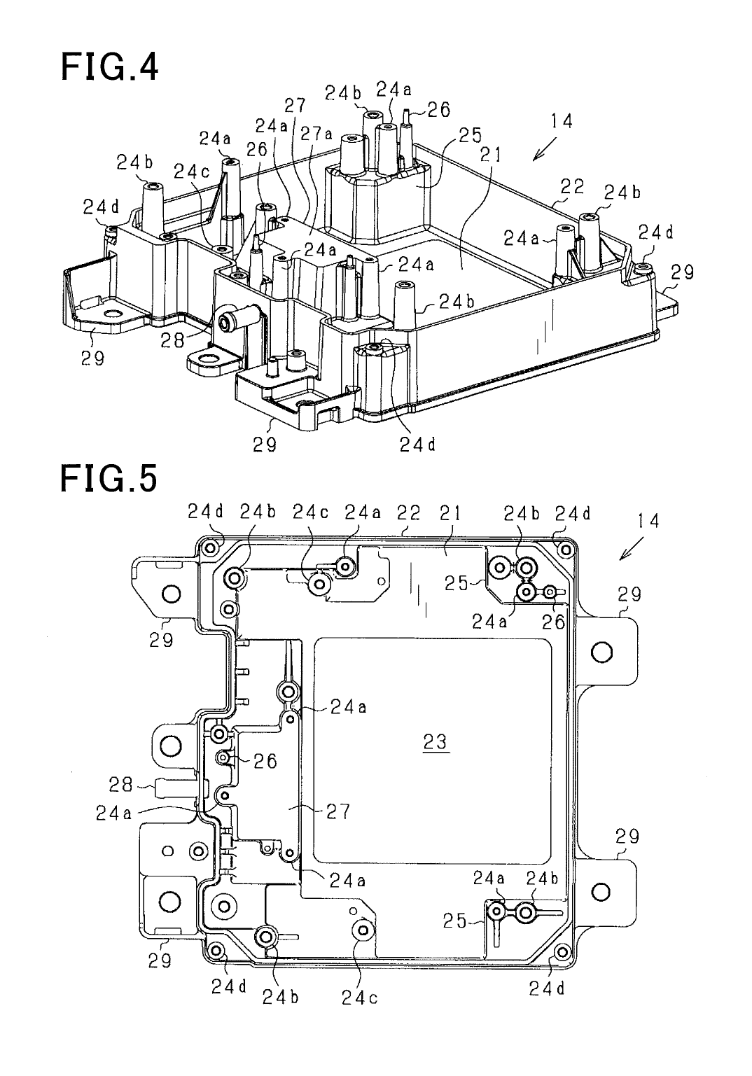

The base 14 of the battery unit 10 will be explained. FIG. 4 is a perspective view of the base 14. FIG. 5 is a plane view of the base 14.

The base 14 is made from a metallic material such as aluminum and includes a bottom plate 21 and an upright wall 22 extending vertically from the bottom plate 21. The bottom plate 21 is substantially square in shape and has a circumferential edge from which the upright wall 22 extends. In other words, the upright wall 22 surrounds the circumference edge of the bottom plate 21. The bottom plate 21 serves as a module mount on which the assembled battery module 11 is retained. The upright wall 22 is so shaped as to completely encompass the assembled battery module 11 mounted on the bottom plate 21.

The base 14, as illustrated in FIG. 5, has a module mount surface 23 which is defined by a portion of a bottom wall of the base 14 and with which the assembled battery module 11 is mounted in direct contact. The module mount surface 23 protrudes slightly from its surrounding area of the base 14 and has an upper even surface formed by, for example, grinding or polishing. The upright wall 22 is of an annular shape and surrounds the assembled battery module 11.

To the base 14, the assembled battery module 11, the control board 12, the cover 15, and the intermediate case 16 are fastened. Specifically, the base 14 has a plurality of cylindrical fixing portions 24a to 24d which are used as fastener supports for securing the assembled battery module 11, the control board 12, the cover 15, and the intermediate case 16 to the base 14. The cylindrical fixing portions 24a to 24d will be also generally denoted by a reference number 24 below. The cylindrical fixing portions 24a are the fastener supports for the control board 12. The cylindrical fixing portions 24b are the fastener supports for the cover 15. The cylindrical fixing portions 24a and 24b extend vertically from the bottom of the base 14 inside the upright wall 22 and have top ends on which the control board 12 and the cover 15 are mounted. The base 14 also has formed on inner corners of the upright wall 22 base blocks 25 on which some of the cylindrical fixing portions 24a and 24b extend upwardly.

The cylindrical fixing portions 24c are the fastener supports for the assembled battery module 11 and located inside the upright wall 22. The cylindrical fixing portions 24c are lower in height than the upper end of the upright wall 22. The cylindrical fixing portions 24d are the fastener supports for the intermediate case 16 and located outside the upright wall 22.

The top end of each of the cylindrical fixing portions 24a to 24d has an even surface extending in the same direction as that in which the bottom surface of the bottom plate 21 extends. The top end of each of the cylindrical fixing portions 24a to 24b has a threaded hole formed therein. The installation of the assembled battery module 11, the control board 12, the cover 15, and the intermediate case 16 on the base 14 is achieved by placing them on the top ends of the cylindrical fixing portions 24a to 24d and then fastening screws N into the threaded holes of the cylindrical fixing portions 24a to 24d.

The base 14 also has a plurality of cylindrical locating pins 26 (two in this embodiment) extending upwardly, like the cylindrical fixing portions 24a and 24b. Each of the locating pins 26 has an outer shoulder and is made up of a small-diameter portion and a large-diameter portion. The small-diameter portion works as a positioner to position the control board 12 relative to the base 14.

The base 14 is equipped with a heat dissipator which serves to release heat, as generated by the assembled battery module 11 and the control board 12, to the environment. Specifically, the base 14 has, as illustrated in FIGS. 4 and 5, a heat sink 27 formed as the heat dissipator on the base plate 21 inside the upright wall 22. The heat sink 27 includes a board-facing plate 27a facing the back surface of the control board 12 and a plurality of fins (not shown) disposed below the board-facing plate 27a. The heat sink 27 is opposed to an area of the control board 12 in which power devices P are mounted. The heat, as produced by the power devices P, is transmitted to the board-facing plate 27a and then released from the fins outside the battery unit 10.

The power devices P are implemented by power semiconductor devices. Specifically, power transistors such as power MOSFETs or IGBTs are mounted as the power devices P on a power path leading to the assembled battery module 11 in the battery unit 10. The power devices P are turned on or off to control input or output of electric power into or from the assembled battery module 11. The battery unit 10 is, as described above, connected to the lead-acid battery and the electric generator. The power path leading to the assembled battery module 11 is, thus, connected to the lead-acid battery and the electric generator.

The base 14 has formed on the lower surface of the base plate 21 ribs (not shown) working as a heat dissipator. The heat, as produced by the assembled battery module 11 or the control circuit board 12, is transmitted to the bottom plate 21 through the upright walls 22 and then released from the ribs outside the battery unit 10. The ribs also work as reinforcements.

The upright wall 22 also has formed therein a gas drain port 28 from which gas in the storage case 13 is drained outside the battery unit 10. The bottom plate 21 also has flanges 29 extending outwardly from the upright wall 22. Each of the flanges 29 has a hole through which a bolt passes for installation of the battery unit 10.

### Cover 15

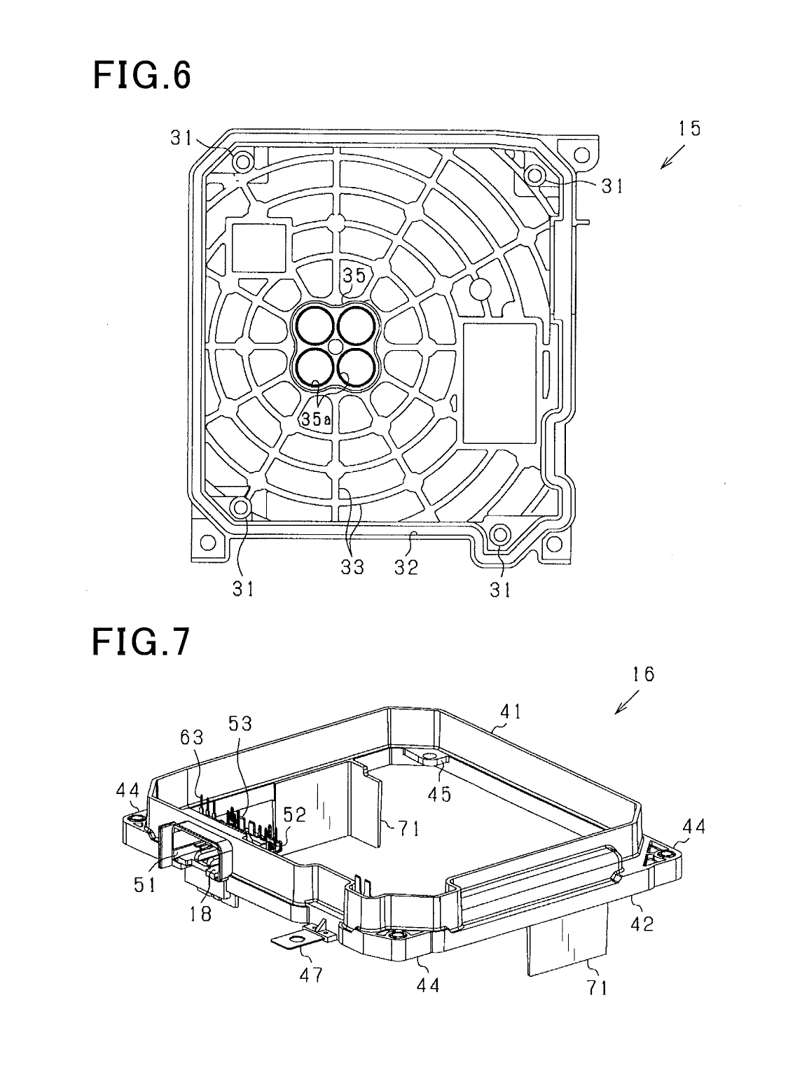

FIG. 6 is a bottom view of the cover 15. The cover 15 is, like the base 14, made from a metallic material such as aluminum. The cover 15 is substantially square in shape and identical in size in a planar view thereof with the base 14 from which the flanges 29 are omitted. The cover 15 has formed on peripheral edges or corners thereof fixing portions 31 which are used as fastener supports to mechanically connect the cover 15 to the base 14. The cover 15 also has formed therein an annular groove 32 in which an upper end of the intermediate case 16 (i.e., an upper end of an intermediate wall 41, as will be described later) is fit. The fixing portions 31 are located at the four corners of the cover 15 in alignment with the cylindrical fixing portions 24b of the base 14. Each of the fixing portions 31 has a threaded hole formed therein. The annular groove 32 extends outside the fixing portions 31 and has a contour conformed to the contour of the upper end of the upright wall 22 of the base 14. The cover 15 has reinforcement ribs 33 formed on the lower surface thereof.

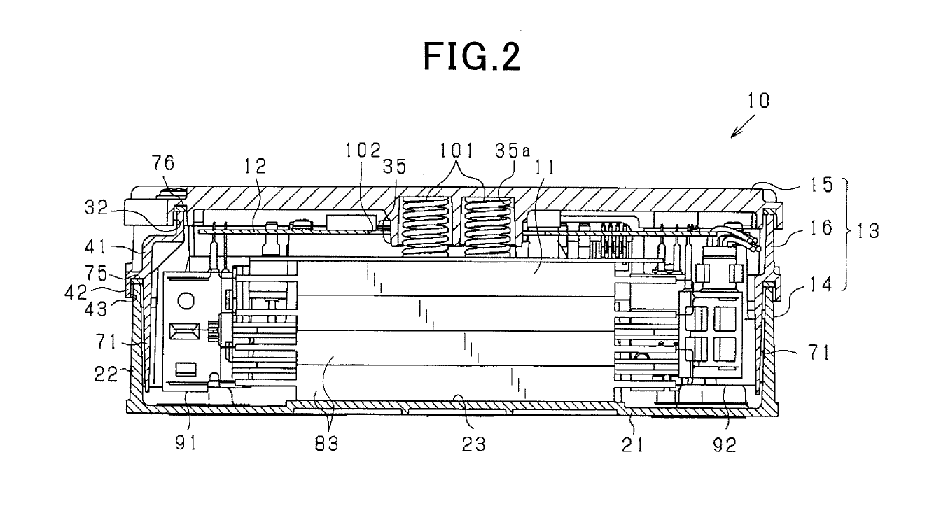

The cover 15 has formed on the lower surface thereof a spring holder 35 designed as a pressing mechanism holder. The spring holder 35 are also used as a spring press to hold coil springs 101, as disposed between the assembled battery module 11 and the cover 15, under pressure. The spring holder 35, as illustrated in FIG. 2, protrude downward from the lower surface of the cover 15 and has formed therein a plurality of cylindrical chambers 35a in which the coil springs 101 are disposed. A pressing mechanism using the coil springs 101 will be described later in detail.

The ribs 33 are disposed in a pattern radiating from the spring holder 35 to minimize the deformation or warp of the cover 15 arising from application of a mechanical load (i.e., reactive force of the springs 101 oriented to lift the cover 15 upward) to the spring holder 35. Specifically, the spring holder 35 works as a spring support to retain one of ends of each of the coil springs 101. The ribs 33 work as a deformation avoider to minimize the deformation of the cover 15.

The attachment of the cover 15 to the base 14 is achieved by placing each of the fixing portions 31 of the cover 15 on one of the cylindrical fixing portions 24b of the base 14 and fastening the screws N into the fixing portions 31 and the cylindrical fixing portions 24b. The cover 15 is, as can be seen from FIG. 2, located above the upright wall 22 of the base 14, so that a generally square closed window which is unoccupied by both the cover 15 and the base 14 is formed in a peripheral wall of the storage case 13.

### Intermediate Case 16

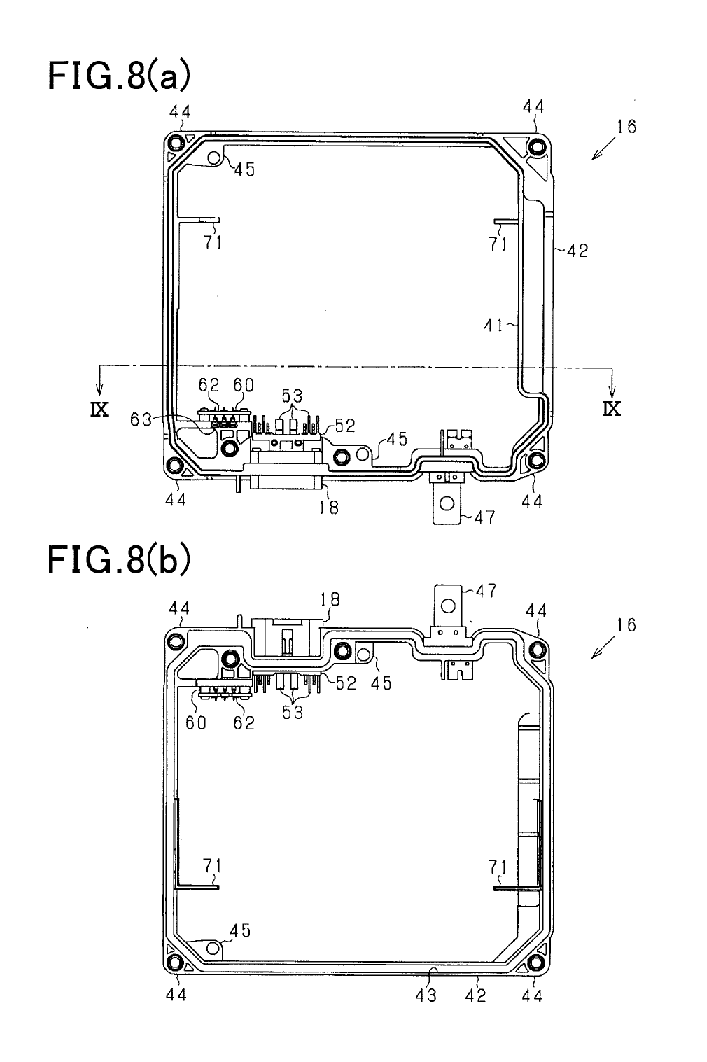

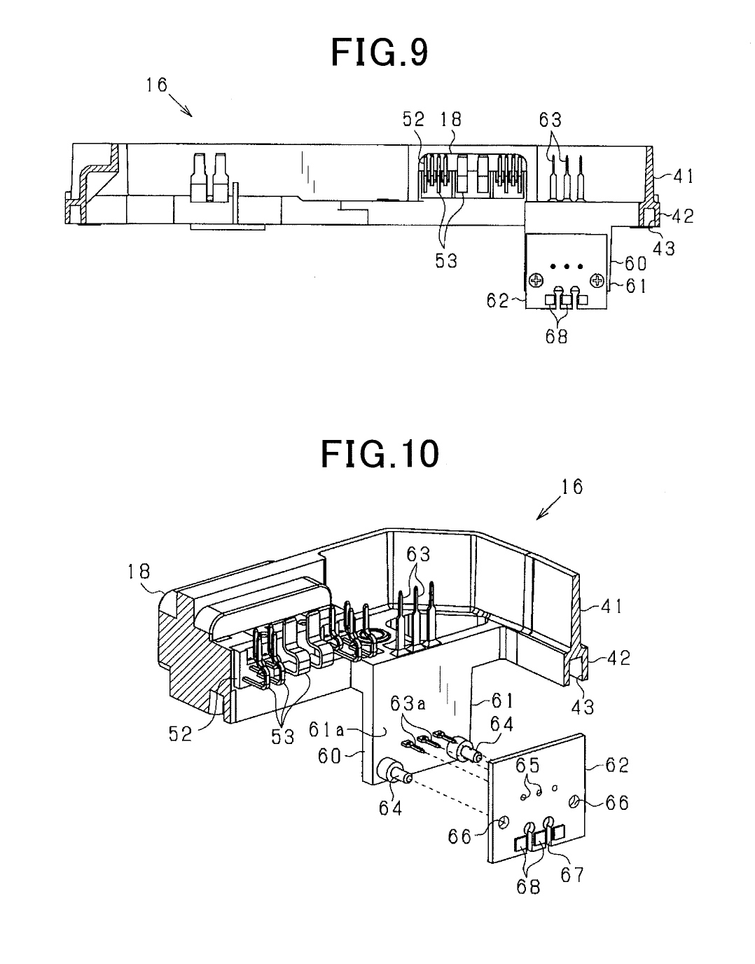

The structure of the intermediate case 16 will be described below. FIG. 7 is a perspective view of the intermediate case 16. FIG. 8(a) is a plane view of the intermediate case 16. FIG. 8(b) is a bottom view of the intermediate case 16. FIG. 9 is a sectional view, as taken along the line IX-IX in FIG. 8(a).

The intermediate case 16 is made of synthetic resin which is lower in stiffness than material of the base 14 and the cover 15. The intermediate case 16 is affixed to the base 14 and continuously extends from the upright wall 22 upward. The cover 15 is mounted on the intermediate case 16. The intermediate case 16 closes the above described square closed window, as unoccupied by both the cover 15 and the base 14.

The intermediate case 16, as illustrated in FIGS. 7, 8(a), and 8(b), has an intermediate wall 41 of a generally square closed shape. The intermediate case 16 has a square closed frame 42 which defines a lower end thereof. The frame 42 has formed therein a square closed groove 43 in which the upper end of the upright wall 22 of the base 14 is fit. The frame 42 has fixing portions 44 formed outside the groove 43 fixing portions 44 which are affixed to the base 14. The fixing portions 44 are located in alignment with the fixing portions 24d of the base 14 and have threaded holes formed therein. The threaded holes extend through the thickness of the fixing portions 44, respectively. The attachment of the intermediate case 16 to the base 14 is achieved by placing the fixing portions 44 on the fixing portions 24d of the base 14 and then fastening screws N into the fixing portions 24d and 44. The intermediate case 16 is disposed on the top end of the upright wall 22 of the base 14.

The intermediate wall 41 has inner tabs in which holes 45 are formed through which the locating pins 26 (i.e., the large-diameter portion) of the base 14 pass, respectively.

The intermediate case 16 has disposed integrally thereon a connecting terminal 47 which is electrically joined to a terminal block 17. The intermediate case 16 also has a connector 18 affixed thereto. The connecting terminal 47 and the connector 18 are arranged adjacent each other in or on the same one of four side walls of the intermediate case 16.

The connector 18 is partially exposed outside the intermediate case 16 and made up of a connector shell 51 into which a connector of a cable harness (not shown) is fit and a male plug 52 with a plurality of terminal pins 53 arrayed inside the connector shell 51. The terminal pins 52 partially extend upward and are electrically soldered to the control board 12. The terminal pins 53 include electric power output terminals (e.g., bus bars) and signal input/output terminals.

The intermediate case 16 is equipped with a water damage sensor 60 disposed inside the intermediate wall 41. The water damage sensor 60 is located closer to the male plug 52 and works as a submergence detection sensor to detect the ingress of water into the battery unit 10, that is, whether the battery unit 10 has been submerged in water or not. FIG. 10 is an enlarged perspective view of the water damage sensor 60.

The water damage sensor 60 essentially consists of an extension plate 61 and a sensor substrate 62. The extension plate 61 extends downward from the frame 42. The sensor substrate 62 is affixed to the extension plate 61. The extension plate 61 is square and has a plurality of connecting terminals (i.e., electric conductors) 63 which are partially embedded therein. The connecting terminals 63 are each made of a bus bar. Each of the connecting terminals 63 has an end which extends upward from an upper end of the extension plate 61 and another end which extends horizontally from a side surface 61a (i.e., a major surface) of the extension plate 61 on which the sensor substrate 62 is mounted. Specifically, each of the connecting terminals 62 is bent at right angles within the extension plate 61. The side surface 61a (which will also be referred to as a substrate-mounted surface below) of the extension plate 61 has two cylindrical protrusions 64 formed on. Each of the cylindrical protrusions 64 is made up of two sections: a small-diameter portion and a large-diameter section. The cylindrical protrusions 64 are located at corners of the substrate-mounted surface 61a of the extension plate 61.

The sensor substrate 62 has formed therein an array of holes 65 in which pins 63a that are the lower ends of the connecting terminals 63 are fit and a pair of holes 66 into which the cylindrical protrusions 64 of the extension plate 61 are inserted. The attachment of the sensor substrate 62 to the substrate-mounted surface 61a of the extension plate 61 is achieved by inserting the pins 63a of the connecting terminals 63 and the cylindrical protrusions 64 of the extension plate 61 into the holes 65 and 66 and fastening the sensor substrate 62 using screws. After affixed to the extension plate 61, the sensor substrate 62 is oriented to have major surfaces extending vertically. The sensor substrate 62 has two slits 67 formed in a lower end thereof. The slits 67 extend vertically in parallel to each other. The sensor substrate 62 also has three water detecting electrodes 68 affixed adjacent the slits 67.

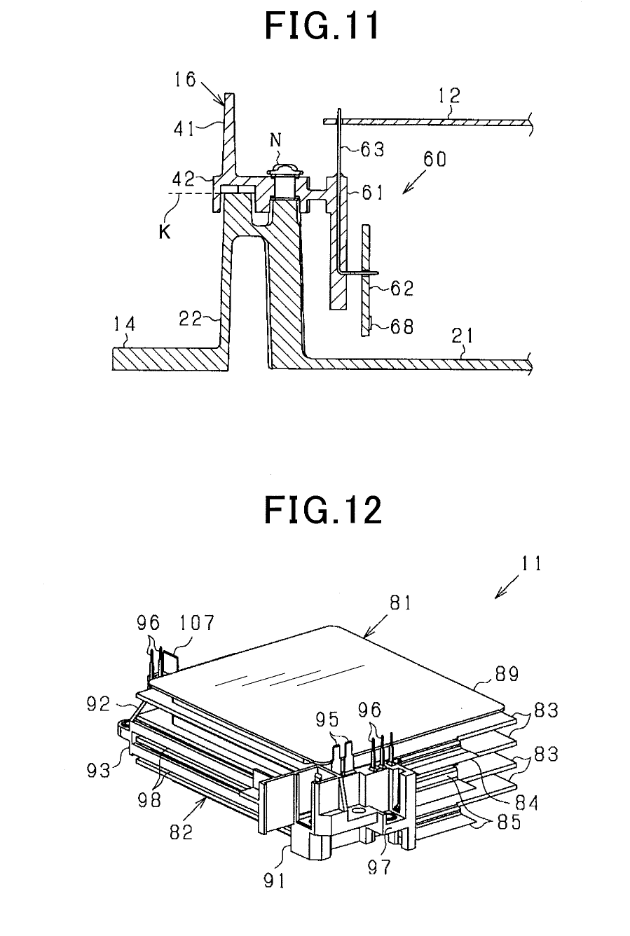

FIG. 11 illustrates the location of the water damage sensor 60 when the intermediate case 16 is attached to the base 14. FIG. 11 is a vertical section view of the water damage sensor 60 when the intermediate case 16 and the base 14 are assembled together.

The extension plate 61 is disposed inside the upright wall 22 of the base 14 when the intermediate case 16 is joined to the base 14. The sensor substrate 62 is located inside the extension plate 61. The three water detecting electrodes 68 are arranged lower than the lower end of the extension plate 61 (i.e., the upper end of the upright wall 22 of the base 14) and near the bottom plate 21. When the water enters the storage chamber 13, it will reach the water detecting electrodes 68 relatively quickly. This causes the water detecting electrodes 68 to be electrically connected to each other to output a signal indicative thereof to the control board 12.

The sensor substrate 62 is, as illustrated in FIG. 11, located beneath the control board 12 and has the major surface (i.e., an electronic component-mounted surface) traversing (i.e., extending substantially perpendicular to) the major surface (i.e., the electronic component-mounted surface) of the control board 12. The water detecting electrodes 68 are disposed at a level lower than an apparent boundary, as denoted by “K” in FIG. 11, between the base 14 and the intermediate case 16. The apparent boundary K lies between the top end of the upright wall 22 of the base 14 and the lower surface of a sealing member 75 fit in the groove 43 of the intermediate case 16. The control board 12 is located higher than the apparent boundary K. The direction in which the sensor substrate 62 extends is identical with that in which electrochemical cells 83 of the assembled battery module 11 are, as clearly illustrated in FIG. 2, laid to overlap each other.

The intermediate case 16, as illustrated in FIG. 7, includes insulating walls 71 extending downward from the frame 42. In the assembly of the intermediate case 16 and the base 14, the insulating walls 71, as clearly illustrated in FIG. 2, continue or extend from the intermediate case 16 toward the bottom plate 21 of the base 14 inside the upright wall 22. In other words, each of the insulating walls 71 is laid to overlap the upright wall 22 in the horizontal direction (i.e., a direction perpendicular to the thickness of the battery unit 10). The insulating walls 71 work to electrically isolate electrodes (i.e., electrode tabs 84 and 85 which will be described later in detail) of the assembled battery module 11 from the upright wall 22 and are located between the electrodes of the assembled battery module 11 and the upright wall 22. The base 14, as described above, has the base blocks 25 located inside the upright wall 22. Each of the insulating walls 71 is, as clearly illustrated in FIGS. 8(a) and 8(b), of an L-shape, in other words, has two wall sections extending perpendicular to each other to electrically isolate the electrodes of the assembled battery module 11 from the base blocks 25.

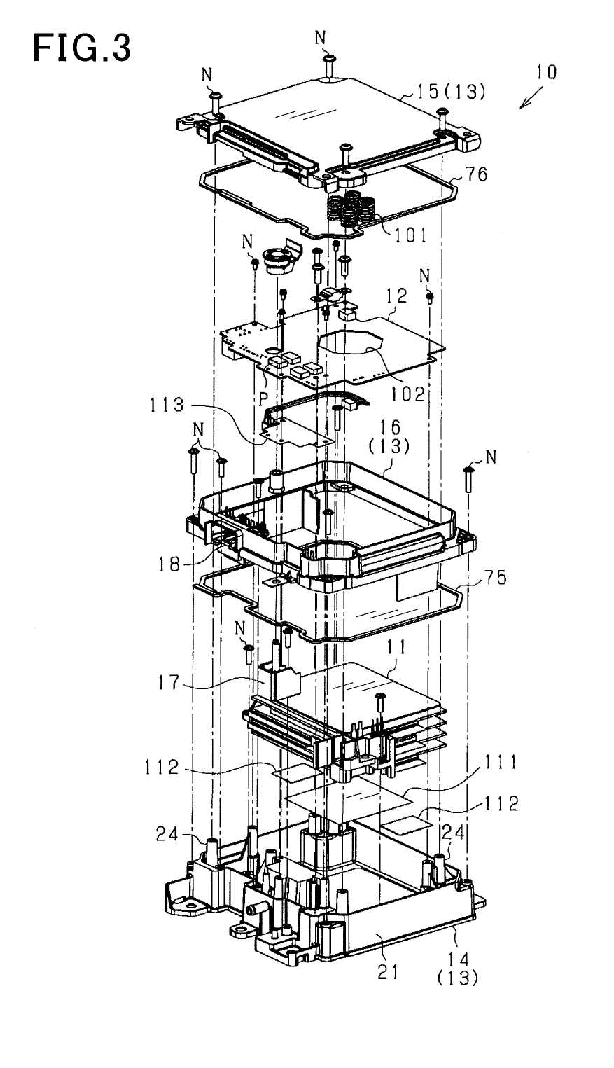

FIG. 2 illustrates the cover 15 and the intermediate case 16 which are fastened to the base 14. The upper end of the upright wall 22 of the base 14 is fit in the groove 43 of the frame 42 of the intermediate case 16. Specifically, the base 14 is fixed to the intermediate case 16 with the lower ends of the fixing portions 44 of the intermediate case 16 being in contact with the fixing portions 24d of the base 14. In this condition, the bottom of the groove 43 of the intermediate case 16 (i.e., one of opposed ends of the intermediate wall 41 which faces the base 14) is located at a given distance away from the upper end of the upright wall 22. The sealing member 75 (i.e., a mechanical seal) fills such an air gap between the groove 43 of the intermediate case 16 and the upper end of the upright wall 22. The sealing member 75 has a configuration, as illustrated in FIG. 3. More specifically, the sealing member 75 is made of an annular strip member. The sealing member 75 is elastically compressed by the upper end of the upright wall 22 to create a liquid tight seal between the base 14 and the intermediate case 16.

The upper end of the intermediate wall 41 of the intermediate case 16 is fit in the groove 43 extending along the peripheral edge of the cover 15. Specifically, the cover 15 is fixed to the base 14 with the lower ends of the fixing portions 31 of the cover 15 being in contact with the fixing portions 24b of the base 14. In this condition, the bottom of the groove 32 of the cover 15 (i.e., one of opposed ends of the cover 15 which faces the base 14) is located at a given distance away from the upper end of the intermediate wall 41. A sealing member 76 (i.e., a mechanical seal) fills such an air gap between the groove 32 of the cover 15 and the upper end of the intermediate wall 41. The sealing member 76 has a configuration, as illustrated in FIG. 3. More specifically, the sealing member 76 is made of an annular strip member. The sealing member 76 is elastically compressed by the upper end of the intermediate wall 41 to create a liquid tight seal between the cover 15 and the intermediate case 16.

As apparent from the above discussion, the upper end of the upright wall 22 of the base 14 is placed in indirect contact with the bottom of the groove 43 of the intermediate case 16. Similarly, the upper end of the intermediate wall 41 of the intermediate case 16 is placed in indirect contact with the bottom of the groove 32 of the cover 15. In other words, buffers are disposed between the base 14 and the intermediate case 16 and between the intermediate case 16 and the cover 15 to avoid direction transmission of external force acting on the cover 15 from above to the intermediate case 16 and to the base 14.

### Assembled Battery Module 11

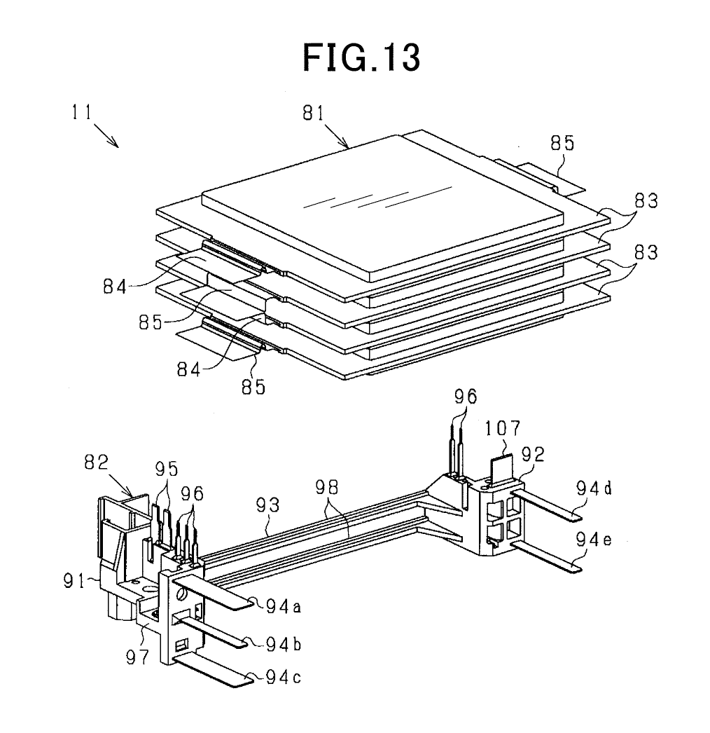

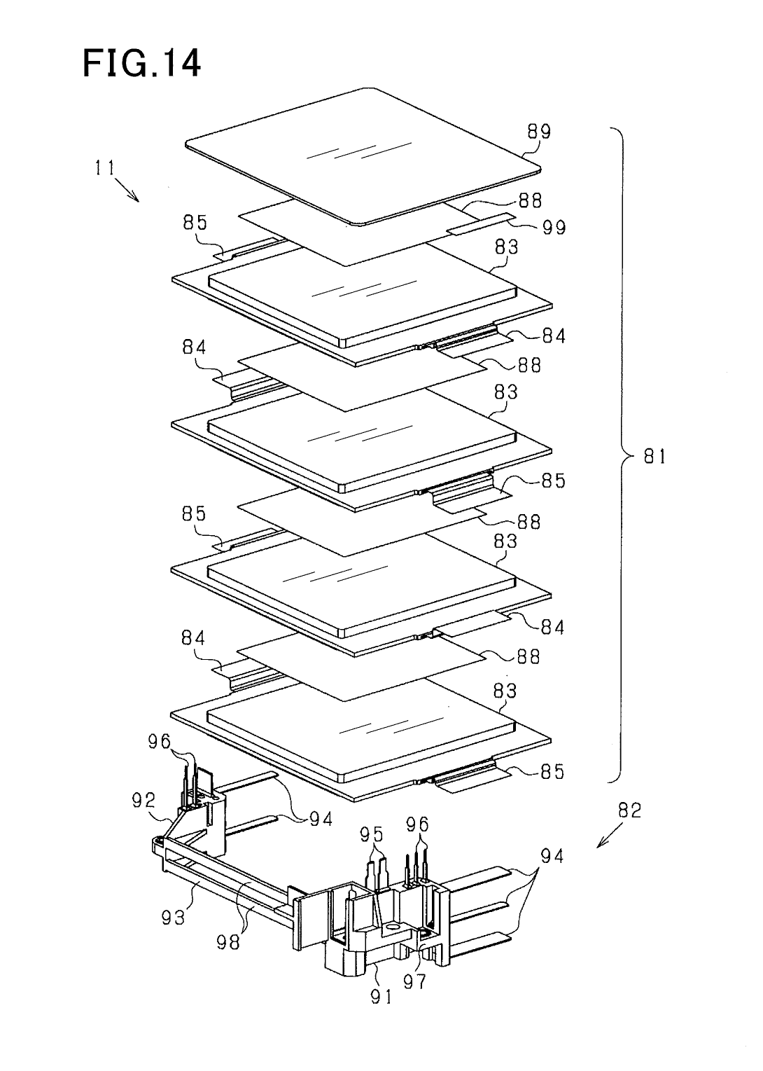

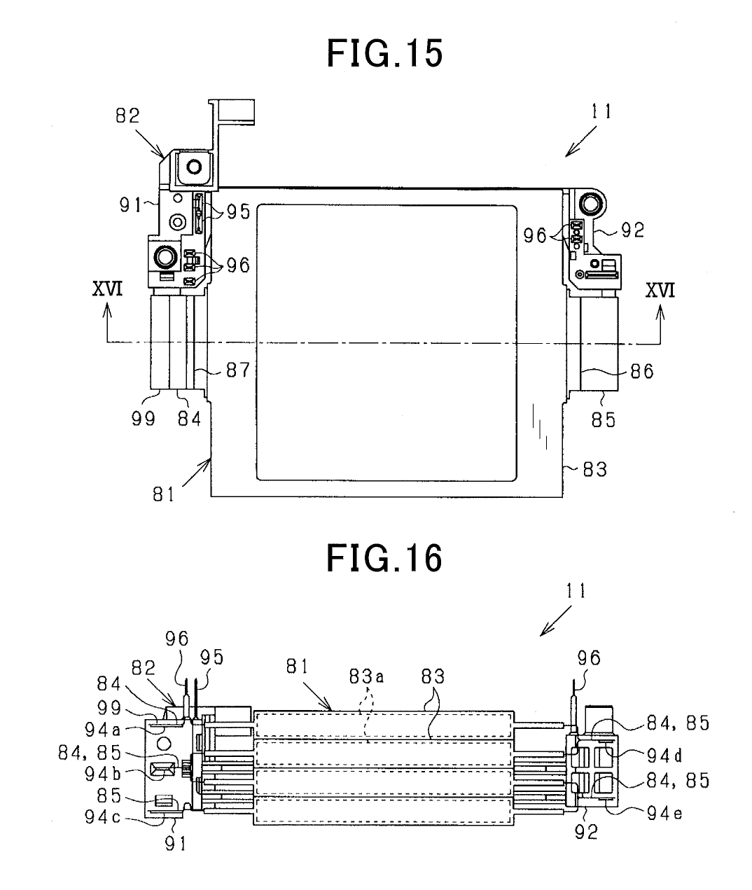

The structure of the assembled battery module 11 will be described below. FIG. 12 is a perspective view which illustrates the overall structure of the assembled battery module 11. FIGS. 13 and 14 are exploded perspective views of the assembled battery module 11. FIG. 15 is a plane view of the assembled battery module 11. FIG. 16 is a sectional view, as taken along the line XVI-XVI in FIG. 15.

The assembled battery module 11 works as a so-called battery and consists essentially of a battery assembly 81 of a plurality (four in this embodiment) of cells 83 and a battery holder 82 fastened to the battery assembly 81 as a bus bar holder. The battery assembly 81 includes the cells 83 each of which is implemented by a laminated-type cell, as described in the introductory part of this application. Specifically, each of the cells 83 is made up of a flexible flattened casing formed by a pair of laminated films and a square cell body 83a, as illustrated in FIG. 16, disposed in the flattened casing. The casing has a peripheral edge sealed to hermetically place the cell body 83a therewithin. The cells 83 are laid to overlap each other in a thickness-wise direction thereof. Each of the cells 83 is of a planar shape and has a pair of electrode tabs 84 and 85 extending outward from the cell body 83a. The electrode tabs 84 and 85 are affixed to diametrically opposed two of four sides of each of the cells 83. The electrode tab 84 serves as a positive electrode. The electrode tab 85 serves as a negative electrode. The positive electrode tab 84 is made of aluminum. The negative electrode tab 85 is made of copper.

The cells 83 are, as described above, stacked vertically. One of vertically adjacent two of the cells 83, as can be seen from FIGS. 12 and 13, has the positive electrode tab 84 disposed on the same side as the negative electrode tab 85 of the other cell 83. In other words, the positive electrode tab 84 of one of vertically adjacent two of the cells 83 is laid over the negative electrode tab 85 of the other cell 83 in the thickness-wise direction of the cells 83. The positive electrode tab 84 of each of the cells 83 is electrically joined to the negative electrode tab 85 of an adjacent one of the cells 83, so that all the cells 83 are electrically connected together in series.

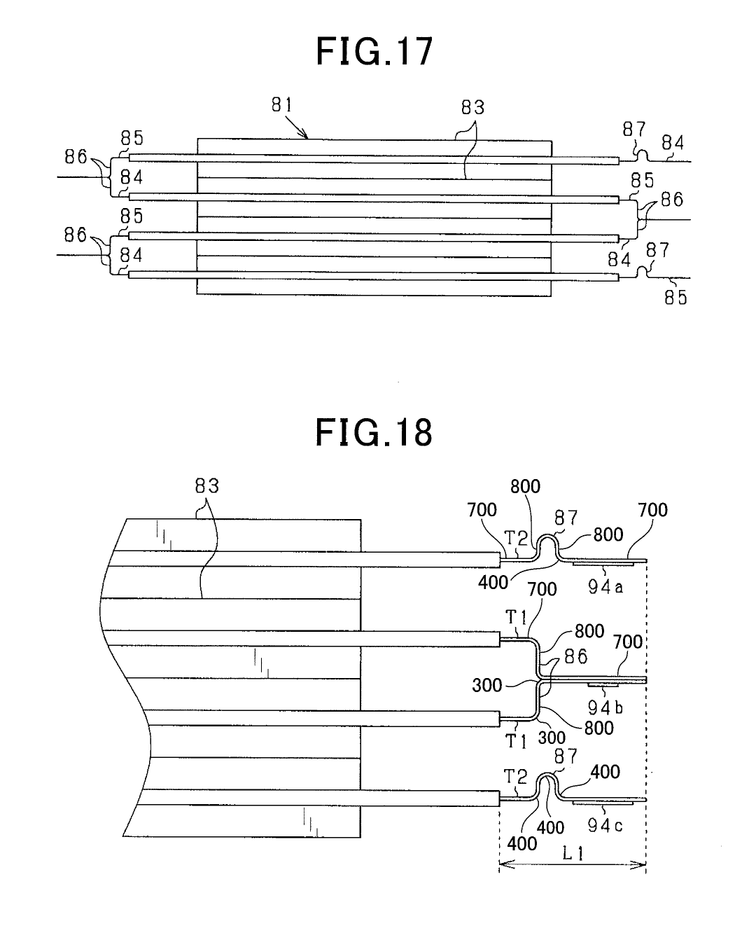

The positive electrode tab 84 and the negative electrode tab 85 of adjacent two of the cells 83 are so physically bent as to get close to each other to have portions laid to overlap each other vertically. Such overlapped portions are joined together, for example, by ultrasonic welding. In this embodiment, the positive electrode tab 84 and the negative electrode tab 85 of the battery assembly 81 are joined in the way, as illustrated in FIG. 17. The electrode tabs 84 and 85 of all the cells 83 are broken down into two types: one being first electrode tabs, and the other being second electrode tabs. The first electrode tabs are the electrode tabs 84 and 85 of every vertically adjacent two of the cells 83 which have portions laid on one another and joined together through a weld, as described later in detail. The second electrode tabs are the electrode tabs 84 and 85 of the cells 83 which are not joined to those of another of the cells 83. More specifically, on the right side of the battery assembly 81, the uppermost positive electrode tab 84 and the lowermost negative electrode tab 85 which extend straight in the horizontal direction are the second electrode tabs, while the uppermost positive electrode tab 84 and the lowermost negative electrode tab 85 of intermediate two of the cells 83 which are bent and welded together are the first electrode tabs. On the left side of the battery assembly 81, the positive electrode tab 84 and the negative electrode tab 85 of upper two of the cells 83 which are bent and welded together are the first electrode tabs. Similarly, the positive electrode tab 84 and the negative electrode tab 85 of lower two of the cells 83 which are bent and welded together are the first electrode tabs.

The first electrode tabs that are some of the electrode tabs 84 and 85 which are laid to overlap each other and joined together between vertically adjacent two of the cells 83 and the second electrode tabs that are the other electrode tabs 84 and 85 which are not joined to one another are different in configuration from each other in a direction in which the electrode tabs 84 and 85 extend. This will be discussed with reference to FIG. 18. FIG. 18 is an enlarged view which illustrates the electrode tabs 84 and 85 on the right side of the cells 83, as shown in FIG. 17, and denotes the electrode tabs 84 and 85 joined together as first electrode tabs T1 and the electrode tabs 84 and 85 not joined together as second electrode tabs T2 for the sake of convenience. Reference numbers 94a, 94b, and 94c indicate bus bars to which the first and second electrode tabs T1 and T2 are connected. The bus bars 94a to 94c will be described later in detail.

Each of the first electrode tabs T1 is, as clearly illustrated in FIG. 13, made of a plate member with major surfaces opposed to each other in a thickness-wise direction thereof. Each of the first electrode tabs T1 includes two lateral portions 700 and one vertical portion 800. The lateral portions 700 extend straight in a lengthwise direction of the first electrode tab T1, that is, a direction perpendicular to a direction in which the cells 83 are stacked. Such a direction will also be referred to as a stacked direction below. The vertical portion 800 extends in the stacked direction. The lateral portions 700 and the vertical portion 800 define a bent portion 86 of a crank shape. A main body of the bent portion 86 (i.e., the vertical portion 800) extends at substantially right angles from a base end portion of the first electrode tab T1 leading to the body of a corresponding one of the cells 83, that is, approaches close to a mating one (i.e., a vertically adjacent one) of the first electrode tabs T1 so as to make an overlap between each adjacent two of the electrode tabs 84 and 85. The bent portion 86 of each of the first electrode tabs T1 lies intermediate between a base end of the first electrode tab T1 continuing directly from the body of a corresponding one of the cells 83 and a joint (or weld) of the first electrode tab T1 to the adjacent one. Each of the first electrode tabs T1 includes two rounded or arc-shaped corners 300 which bulge in opposite directions to define a crank shape of the first electrode tab T1 as a whole. The first electrode tabs T1 have top end portions laid on each other and joined together at a location intermediate between the adjacent two of the cells 83 in the thickness-wise direction of the cells 83. Each of the arc-shaped corners 300 is shaped to have a radius of curvature which minimizes an undesirable degree of stress acting thereon which arises from oscillation occurring during an ultrasonic welding operation or transmitted from the body of the automotive vehicle in the case where the battery unit 10 is mounted on the automotive vehicle. The radii of curvature of the arc-shaped corners 300 may be equal to each other.

Each of the second electrode tabs T2 is, like in the first electrode tabs T1, made of a plate member with major surfaces opposed to each other in a thickness-wise direction thereof. Each of the second electrode tabs T2 includes two lateral portions 700 and two vertical portions 800. The lateral portions 700 extend straight in a lengthwise direction of the second electrode tab T2, that is, a direction perpendicular to the stacked direction. The vertical portions 800 extend in the stacked direction. The lateral portions 700 and the vertical portion 800 of each of the second electrode tabs T2 define a bent portion 87 of a U-shape, as protruding in the stacked direction. The bent portion 87 of each of the second electrode tabs T2 lies between a base end of the second electrode tab T2 continuing directly from the body of the cell 83 and a joint (or weld) to the bus bar 94a or 94c.

Each of the second electrode tabs T2 includes three rounded or arc-shaped corners 400 which bulge in different directions. Specifically, outer two of the arc-shaped corners 400 bulge in substantially the same direction (i.e., the downward direction in FIGS. 17 and 18). A middle one of the arc-shaped corners 400 bulges in a direction (i.e., the upward direction in FIGS. 17 and 18) opposite that in which the outer arc-shaped corners 400 swell. Each of the arc-shaped corners 400 is shaped to have a radius of curvature which minimizes an undesirable degree of stress acting thereon which arises from oscillation occurring during an ultrasonic welding operation or transmitted from the body of the automotive vehicle in the case where the battery unit 10 is mounted on the automotive vehicle. The radii of curvature of the arc-shaped corners 400 may be equal to each other.

The battery unit 10 has a configuration most sensitive to mechanical vibration in a direction in which the cells 83 are stacked, that is, the thickness-wise direction of the cells 83 (i.e., the stacked direction).

The bent portions 86 and 87 are so geometrically shaped as to make all the first and second electrode tabs T1 and T2 have the same length L1 regardless of how to join the first and second electrode tabs T1 and T2 together or to the bus bars 94a to 94c. The length L1 is, as can be seen in FIG. 18, a linear distance between the base end of each of the first and second electrode tabs T1 and T2 leading to the cell 83 and the tip end thereof. Accordingly, the same linear length L1 of the first and second electrode tabs T1 and T2 makes the tip ends of all the first and second electrode tabs T1 and T2 aligned in the stacked direction of the cells 83. Specifically, the first and second electrode tabs T1 and T2 extending on the same side of the cells 83 have the tip ends aligned in the stacked direction of the cells 83. This eliminates the need for regulating lengths of all strips of which the first and second electrode tabs T1 and T2 are made and permits the first and second electrode tabs T1 and T2 to be joined together or to the bus bars 94a to 94c at the same location in the direction in which the first and second electrode tabs T1 and T2 extend. The bent portions 87 of the second electrode tabs T2 serve as a length adjuster to adjust the length of the second electrode tabs T2 so as to align the joints of the second electrode tabs T2 with the joints of the first electrode tabs T1 in the stacked direction of the cells 83. This causes the centers of the joints (welds) of the second electrode tabs T2 to the bus bars 94 and the centers of the joints (welds) of the first electrode tabs T1 to one another (i.e., to the bus bar 94) to be located at the same distance away from the bodies of the cells 83 in the direction in which the first and second electrode tabs T1 and T2 extend.

An adhesion tape 88 is, as illustrated in FIG. 14, interposed between every two of the cells 83 to bond all the cells 83 together. The battery assembly 81 also has a rigid plate 89 affixed to the surface of the uppermost one of the cells 83 through the adhesion tape 88. The rigid plate 89 is made of, for example, iron sheet which has a surface area which is at least equal to that of each of the cells 83. In this embodiment, the surface area of the rigid plate 89 is greater in size than those of the cells 83. The rigid plate 89 serves as a spring support to mechanical loads, as produced by the coil springs 101.

The battery holder 82 is equipped with a first retainer 91, a second retainer 92, and a connector 93 which connects the first and second retainers 91 and 92 together. The first retainer 91 is attached to the electrode tabs 84 and 85 on one of the sides of the battery assembly 81, while the second retainer 92 is attached to the electrode tabs 84 and 85 on the opposed side of the battery assembly 81. The first retainer 91, the second retainer 92, and the connector 93 are formed integrally by synthetic resin.

The first retainer 91 has three bus bars 94a, 94b, and 94c which will be generally denoted by reference numeral 94 below. The bus bars 94a, 94b, and 94c are laid to overlap each other in the stacked direction of the cells 83 and cantilevered by the first retainer 91. The bus bars 94a, 94b, and 94c are electrically connected to the positive and negative electrode tabs 84 and 85 extending from one of the opposed two of the sides of the battery assembly 81. The bus bars 94a, 94b, and 94c have major surfaces facing each other in the vertical direction (i.e., the thickness-wise direction of the battery assembly 81). Each of the bus bars 94a, 94b, and 94c has one of the major surfaces which is joined in direct contact with the surface of a corresponding one of the positive and negative electrode tabs 84 and 85, as illustrated on the right side of FIG. 18. The bus bars 94a, 94b, and 94c are, as can be seen in FIG. 18, aligned with each other in the stacked direction of the cells 83. In other words, the bus bars 94a, 94b, and 94c are located away from the cell bodies 83a and placed in substantially in the same position in the direction in which the electrode tabs 84 and 85 extend. The bus bar 94a works as a positive terminal of the battery assembly 81 (i.e., a positive terminal of a series circuit made up of the cells 83 connected in series). The bus bar 94c work as a negative terminal of the battery assembly 81 (i.e., a negative terminal of the series circuit). The bus bars 94a and 94c are connected to the power terminals 95 of the battery assembly 81, respectively.

The second retainer 92 has three bus bars 94d and 94e which will be generally denoted by reference numeral 94 below. The bus bars 94d and 94e are laid to overlap each other in the stacked direction of the cells 83 and cantilevered by the second retainer 92. The bus bars 94d and 94e are electrically connected to the positive and negative electrode tabs 84 and 85 extending from the other of the opposed two of the sides of the battery assembly 81. The bus bars 94d and 94e have major surfaces facing each other in the vertical direction (i.e., the thickness-wise direction of the battery assembly 81). Each of the bus bars 94d and 94e has one of the major surfaces which is joined in direct contact with the surface of a corresponding one of the positive and negative electrode tabs 84 and 85, as illustrated on the left side of FIG. 16. The bus bars 94d and 94e are, as can be seen in FIG. 16, aligned with each other in the stacked direction of the cells 83. In other words, the bus bars 94d and 94e are located away from the cell bodies 83a and placed in substantially in the same position in the direction in which the electrode tabs 84 and 85 extend.

The battery assembly 81 is designed to measure a terminal voltage appearing at each of the cells 83. Specifically, the first retainer 91 has three voltage detecting terminals 96 connected to the bus bars 94a, 94b, and 94c, respectively. The second retainer 92 has two voltage detecting terminals 96 connected to the bus bars 94d and 94e. The power terminals 95 and the voltage detecting terminals 96 all extend upward and have top ends joined to the control board 12.

Each of the voltage detecting terminals 96 may be made by a portion of one of the bus bars 94 (94a to 94e). In other words, each of the bus bars 94 may be used in detecting the terminal voltage at the cells 83. In this embodiment, each of the bus bars 94 is connected at one end to one of the positive and negative electrode tabs 84 and 85 of the battery assembly 81 and at the other end to the control board 12 as the voltage detecting terminals 96. Each of the bus bars 94 is bent and partially embedded in one of the first and second retainers 91 and 92. The bus bars 94 work as connecting member joined electrically to the control board 12 that is one of electric devices disposed in the battery unit 10. The bus bars 94 also works as connecting members joined electrically to an external zinc cell or battery disposed outside the battery unit 10.

The connector 93 is made up of an upper and a lower connecting bar 98. In other words, the connector 93 has a horizontal elongated opening or slit to have the upper and lower connecting bards 98. Each of the connecting bars 98 has a width which is, as can be seen from FIG. 12, small enough to be disposed in the space between the peripheral edges of the laminated films of vertically adjacent two of the cells 83. In the condition where the battery holder 82 is attached to the battery assembly 81, the connecting bars 98 each extend between the laminated films of the cells 83 without protruding from the periphery of the battery assembly 81. This is beneficial in reducing the overall size of the battery unit 10.

Each of the first and second retainers 91 and 92 has a height (i.e., a vertical dimension of the resinous body of each of the first and second retainers 91 and 92) which is, as can be seen in FIG. 2, smaller than an overall thickness of the battery assembly 81 (i.e., a vertical dimension of the battery assembly 81 in a direction in which the cells 93 are stacked). This enables the assembled battery module 11 to be mounted on the base 14 without any physical interference of the retainers 91 and 92 with any parts of the battery unit 10.

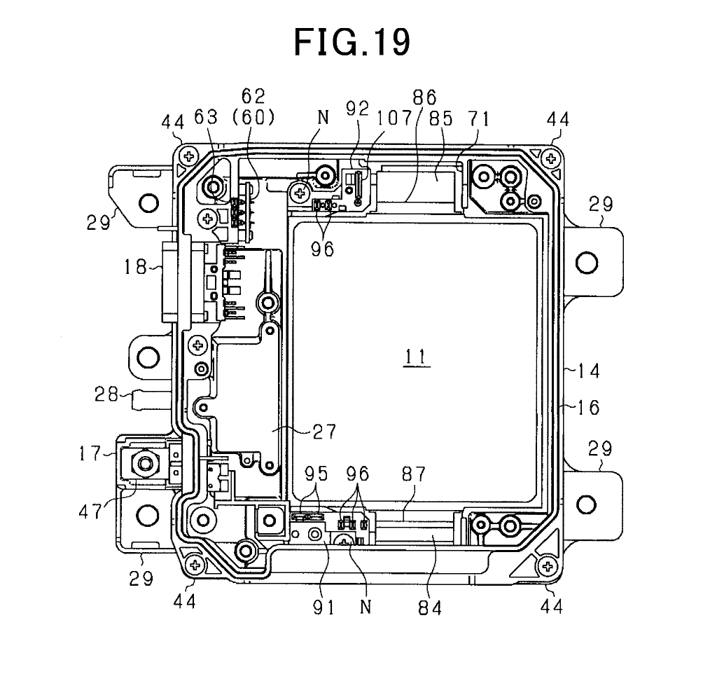

FIG. 19 is a plane view which illustrates the assembled battery module 11 mounted on the base 14 to which the intermediate case 16 is attached.

As viewed from the connector 18 of the intermediate case 16, the assembled battery module 11 is placed with the electrode tabs 84 and 85 located on the right and left sides of the body of the assembled battery module 11. The assembled battery module 11 is also arranged adjacent the heat sink 27 on the base 14. The battery holder 28 is fit in one of the sides of the assembled battery module 11 which is closer to the heat sink 27, that is, the connector 18 and the connecting terminal 47. The assembled battery module 11 is fixed on the base 14 with mounting walls 97 of the battery holder 82 (i.e., the first and second retainers 91 and 92) being fastened to the fixing portions 24c of the base 14 through screws N.

The double-sided tape (also called double stick tape) 111 is, as illustrated in FIG. 3, disposed below the body of the assembled battery module 11. The double-sided tape 111 bonds the bottom surface of the assembled battery module 11 to the base 14. The insulating sheets 112 are placed below the electrode tabs 84 and 85 of the battery assembly 81 to electrically isolate the electrode tabs 84 and 85 from the bottom plate 21.

### Ultrasonic Welding of Electrode Tabs

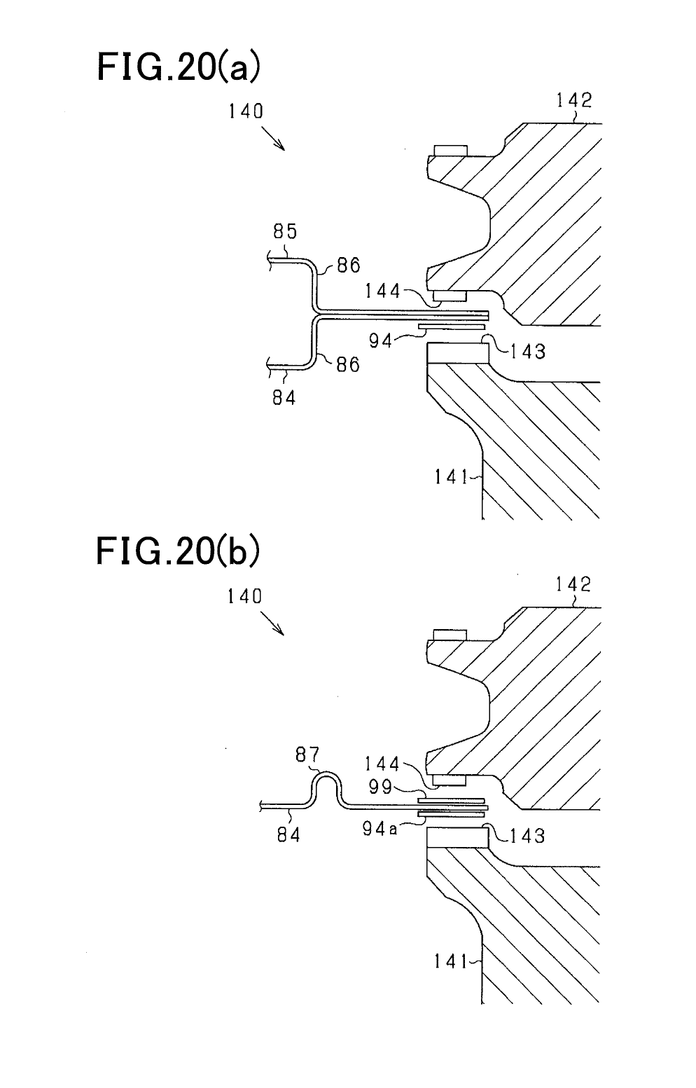

The ultrasonic welding of the electrode tabs 84 and 85 of the assembled battery module 11 will be described below. FIGS. 20(a) and 20(b) illustrate a ultrasonic welding machine 140 used to achieve the welding of the electrode tabs 84 and 85 and the bus bars 94. The ultrasonic welding machine 140 is equipped with an anvil 141 (i.e., a fixed table) and a horn 142 (i.e., a sonotrode). The anvil 141 and the horn 412 have shaped surfaces 143 and 144, respectively, on which fine irregularities or indentations are formed. The formation of indentations are achieved by, for example, knurling.

The joining of the positive electrode tab 84 and the negative electrode tab 85 is accomplished by laying the positive electrode tab 84 and the negative electrode tab 85 of adjacent two of the cells 83 to overlap each other and ultrasonic-welding such an overlap. The positive electrode tab 84 is, as described above, made of aluminum, while the negative electrode tab 85 is made of copper. The positive electrode tab 84 is, thus, lower in hardness than the negative electrode tab 85. This gives rise to fears that the ultrasonic welding of the positive electrode tab 84 and the negative electrode tab 85 simply retained between the shaped surfaces 143 and 144 result in physical damage on the positive electrode tab 84 which is lower in hardness.

In order to alleviate the above problem, the bus bar 94 is used as a reinforcement plate to protect the positive electrode tab 84 physically. The bus bar 94 is made from, for example, copper. Specifically, the positive electrode tab 84 and the negative electrode tab 85 are, as clearly illustrated in FIG. 20(a), placed to overlap each other, so that the positive electrode tab 84 is located on a lower side, that is, faces the anvil 141, while the negative electrode tab 85 is put on an upper side, that is, faces the horn 412. The bus bar 94 is disposed between the anvil 141 and the positive electrode tab 84. With this layout, the positive electrode tab 84 which is lower in hardness is sandwiched between the negative electrode tab 85 and the bus bar 94 which are higher in hardness with the negative electrode tab 85 and the bus bar 94 being placed in contact with the shaped surfaces 143 and 144 of the ultrasonic welding machine 140, respectively. The ultrasonic vibrations are applied by the ultrasonic welding machine 140 to the positive electrode tab 84, the negative electrode tab 85, and the bus bar 94 to weld them together. During the ultrasonic welding operation, the positive electrode tab 84 which is lower in hardness is kept out of physical contact with the shaped surfaces 143 and 144, thus resulting in no damage thereto.

One of the positive electrode tabs 84 which is used as a battery positive terminal (also called an overall plus terminal) of the battery assembly 81 of the assembled battery module 11 is, as already described, joined to the bus bar 94 (i.e., the bus bar 94a in FIGS. 13 and 18) without connected to the negative electrode tab 85. The ultrasonic welding of the one of the positive electrode tabs 84 is described with reference to FIG. 20(b). The bus bar 94a is, as clearly illustrated in the drawing, disposed beneath the positive electrode tab 84, that is, over the anvil 141. A contact plate 99 is laid on the positive electrode tab 84, that is, beneath the horn 99. The contact plate 99 functions as a reinforcement or protector made of material which is higher in hardness than the positive electrode tab 84 and made from, for example, copper. Specifically, the positive electrode tab 84 which is lower in hardness is sandwiched between the bus bar 94a and the contact plate 99 which are higher in hardness. The ultrasonic vibrations are applied by the ultrasonic welding machine 140 to the positive electrode tab 84, the bus bar 94a, and the contact plate 99 to weld them together. During the ultrasonic welding operation, the positive electrode tab 84 which is lower in hardness is kept out of physical contact with the shaped surfaces 143 and 144, thus resulting in no damage thereto. The contact plate 99 is usually kept welded to the positive electrode tab 84 and the bus bar 94a, but may alternatively be removed therefrom after completion of the ultrasonic welding operation. FIG. 18 omits the contact plate 99 for the sake of simplicity.

One of the negative electrode tabs 85 which is used as a battery negative terminal (also called an overall minus terminal) of the battery assembly 81 of the assembled battery module 11 is, as already described, joined to the bus bar 94 (i.e., the bus bar 94c in FIGS. 13 and 18) without connected to the positive electrode tab 84. The negative electrode tabs 85 are not made from aluminum which is lower in hardness. The welding of the negative electrode tab 85 and the bus bar 94c is, therefore, achieved without use of the contact plate 99. In other words, the negative electrode tab 85 and the bus bar 94c are subjected directly to the ultrasonic vibrations, as produced by the ultrasonic welding machine 140.

The electrode tabs 84 and 85, as described above, have the bent portions 86 and 87. The bent portions 86 and 87 serve as vibration absorbers to absorb fine or high-frequency oscillations transmitted to the electrode tabs 84 and 85 when subjected to the ultrasonic welding in the ultrasonic welding machine 140, thereby eliminating undesirable stress acting on the electrode tabs 84 and 85. The electrode tabs 84 and 85 are substantially identical with each other in length of material thereof between the ultrasonic weld and the base end leading to the body of the cells 83, thus resulting in uniformity of effects of heat, as generated at the welds during the ultrasonic welding operation, on the cells 83.

The bus bars 94 of the battery holder 82 are all placed at substantially the same distance from the cell bodies 83a. Specifically, all the bus bars 94 have longitudinal centers located at the same distance away from the cell bodies 83a. Additionally, all the electrode tabs 84 and 85 have the tip ends located at the same distance from the cell bodies 83a in the direction in which the electrode tabs 84 and 85 extend outwardly from the cell bodies 83a. This eliminates the need for changing the configuration of the anvil 141 and/or the horn 142 of the ultrasonic welding machine 140 and regulating conditions of the ultrasonic welding, and also avoids physical interferences of the tip ends of the electrode tabs 84 and 85 with the ultrasonic welding machine 140 during the welding operation.

Referring back to FIG. 16, the three bus bars 94a to 94c are welded to the electrode tabs 84 and 85 in the first retainer 91 of the battery holder 82. Specifically, each of the bus bars 94a to 94c is, as already described, disposed below a corresponding one of the electrode tabs 84 and 85 and joined together. More specifically, an uppermost one of the electrode tabs 84 and 85, that is, the positive electrode tab 84 is sandwiched between the bus bar 94a and the contact plate 99 and welded together. A middle one of the electrode tabs 84 and 85, that is, the positive electrode tab 84 is sandwiched between the negative electrode tab 85 and the bus bar 94b and welded together. A lowermost one of the electrode tabs 84 and 85, that is, the negative electrode tab 85 is placed on the bus bar 94c and they are welded together.

The two bus bars 94d and 94e are joined to the electrode tabs 84 and 85 in the second retainer 92 of the battery holder 82. Specifically, each of the bus bars 94d and 94e is put below a combination of the electrode tabs 84 and 85 and joined together. The welding of bus bars 94d and 94e is achieved in the same way in which the positive electrode tab 84 is located between the negative electrode tab 85 and the bus bar 94.

Each of the bus bars 94a, 94b, and 94c of the first retainer 91 is set at a level corresponding to the height of a mating part, i.e., a corresponding one or a corresponding combination of the electrode tabs 84 and 85. Therefore, when the battery holder 82 is attached to the battery assembly 81, each of the bus bars 94 will be put and stay on a corresponding one or a corresponding combination of the electrode tabs 84 and 85, thus facilitating the ease of the welding operation on the bus bars 94 and the electrode tabs 84 and 85.

The bus bar 94a used as the positive terminal of the battery assembly 81 and the bus bar 94c used as the negative terminal of the battery assembly 81 work as main power paths and thus are designed to be wider than the other bus bars 94b, 94d, and 94e. The bus bars 94a to 94e all have the same thickness in order to standardize the ultrasonic welding conditions.

The production method of the assembled battery module 11 will be explained briefly. How to make the battery assembly 81 will first be discussed. The electrode tabs 84 and 85 of each of the four cells 83 are bent into predetermined shapes, respectively. The cells 83 are stacked to overlap each other with the positive electrode tab 84 or the negative electrode tab 85 of one of vertically adjacent two of the cells 83 being placed on the negative electrode tab 85 or the positive electrode tab 84 of the other cell 83. The adhesion tape 88 is disposed between every two of the cells 83 to bond all the cells 83 together. This causes the positive electrode tabs 84 and the negative electrode tabs 85 to have the top portions laid to overlap each other except the electrode tabs 84 and 85 used as the positive and negative terminals of the battery assembly 81.

Next, the battery holder 82 which is produced separately from the battery assembly 81 is attached to the battery assembly 81. Such attachment is achieved by aligning the battery holder 82 with a direction in which two sides of the battery assembly 81 where there are no electrode tabs 84 and 85 are opposed to each other and fitting the battery holder 82 on the battery assembly 81. This causes the bus bars 94 (94a to 94e) extending laterally from the battery holder 82 to be placed just beneath the electrode tabs 84 and 85 of the battery assembly 81. The connector 93 (i.e., the connecting bars 98) of the battery holder 82 is inserted into an air gap between the laminated films of vertically adjacent two of the cells 83. Specifically, each of the connecting bars 98 is fit in the air gap between the laminated films (i.e., peripheral edges) of adjacent two of the cells 83.

After the cells 83 are stacked and electrically connected in series with each other, such a stack, as described above, includes some overlaps of the positive electrode tabs 84 and the negative electrode tabs 85. Each of all the overlaps has the positive electrode tab 84 placed below the negative electrode tab 85. Each of the bus bars 94 is laid below one of the overlaps so that the positive electrode tab 84 is interposed between the negative electrode tab 85 and the bus bar 94. Such each stack of the bus bar 94, the positive electrode tab 84, and the negative electrode tab 85 is then welded by the ultrasonic welding machine 140.

### Control Board 12

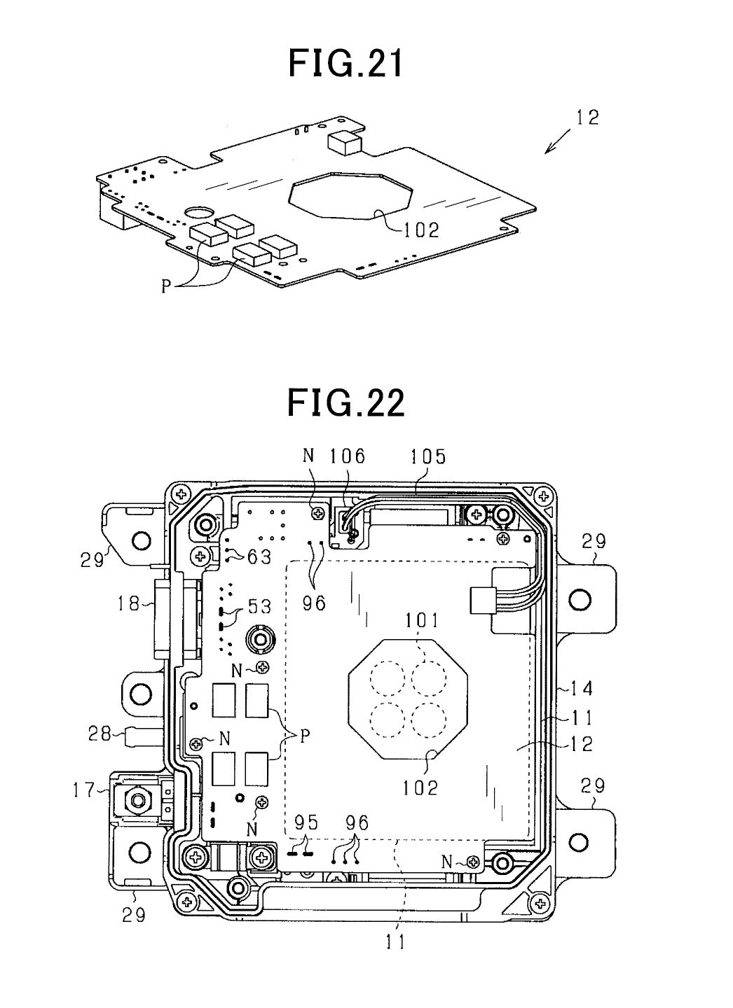

The structure of the control board 12 will be described below. FIG. 21 is a perspective view of the control board 12. FIG. 22 is a plane view which illustrates the control board 12 mounted on the base 14. In FIG. 22, a broken line indicates the location of the assembled battery module 11 (i.e., the rigid plate 87) for the sake of simplicity.

The control board 12 is made of a printed circuit board which has a variety of electronic devices mounted on a major surface thereof. The surface of the control board 12 on which the electronic devices are fabricated will also be referred to as an electronic component-mounted surface below. Specifically, the control board 12 is equipped with a CPU (i.e., an arithmetic device) working as controller to perform a given control task to control charging and discharging operations of the assembled battery module 11 and the above described power devices P. The control board 12 is laid to overlap with the assembled battery module 11 vertically, that is, arranged just above the assembled battery module 11 in the vertical direction thereof. In other words, the control board 12 is located farther away from the bottom plate 21 than the assembled battery module 11 is.

The control board 12 has the lower surface that is opposite the surface on which the power devices P, etc. are fabricated. The lower surface is placed on the fixing portions 24a of the base 14 and fastened to the base 14 through the screws N. Specifically, the control board 12 is, as can be seen from FIGS. 3 and 18, fastened at a plurality of locations to the base 14 through the screws N.

The water detecting electrodes 68 of the water damage sensor 60 are located near the bottom plate 21 of the base 14 so that the CPU (i.e., the controller) on the control board 12 may analyze an output from the water damage sensor 60 which indicates the immersion of the battery unit 10 in water to perform given tasks to, for example, stop charging or discharging the assembled battery module 11 before the battery unit 10 breaks down due to the immersion thereof in water.

The control board 12 has two areas: an overlap area which is laid to overlap with the assembled battery module 11 vertically, that is, arranged just above the assembled battery module 11 in the vertical direction thereof and a non-overlap area which is located out of coincidence with the assembled battery module 11 in the vertical direction. The power devices P are fabricated on the non-overlap area. The non-overlap area is located just above, in other words, faces the heat sink 27 of the base 14, as illustrated in FIG. 5, thereby facilitating the release of heat, as generated by the power devices P, outside the assembled battery module 11 through the heat sink 27.

The insulating sheet 113 is, as illustrated in FIG. 3, interposed between the board-facing plate 27a of the heat sink 27 and the control board 12 to electrically isolate the heat sink 27 from the control board 12.

The joining of the control board 12 to the base 14 is achieved by inserting the terminal pins 53 and the connecting terminals 63 of the intermediate case 16 and the power terminals 95 and the voltage detecting terminals 96 of the assembled battery module 11 into holes formed in the control board 12 and then soldering them.

A temperature sensor 106 made of a thermistor is, as illustrated in FIG. 22, connected to the control board 12 through wires 105. The temperature sensor 106 is mounted on the assembled battery module 11 and works to measure the temperature of the assembled battery module 11. Specifically, the battery holder 82 of the assembled battery module 11 has, as illustrated in FIG. 12, a sensor mount 107 extending upward. The temperature sensor 106 is affixed to the sensor mount 107.

The battery unit 10 is, as described above, equipped with the pressing mechanism to press the assembled battery module 11 from above and hold it within the storage case 13. Specifically, the pressing mechanism is equipped with the coil springs 101, as illustrated in FIG. 2, arranged between the upper surface of the assembled battery module 11 and the cover 15 to press the assembled battery module 11 against the base 14. The installation of the coil springs 101 between the assembled battery module 11 and the cover 15 results in concern about physical interference between the control board 12 and the coil springs 101.

In order to alleviate the above problem, the control board 12 has a hole 102 passing through the thickness thereof to define a spring chamber in which the coil springs 101 are disposed. Each of the coil springs 101 has a length (i.e., an axis) which expands or contracts and is, as clearly illustrated in FIG. 2, disposed in the hole 102 with the length extending substantially perpendicular to the major surface of the control board 12. The hole 102 serves as an interference avoider to eliminate the physical interference between the control board 12 and the coil springs 101. The control board 12 is of a doughnut shape as a whole. The hole 102 is, as shown in FIGS. 21 and 22, of a polygonal shape, but may be circular.

Supplementing the explanation of the above pressing mechanism, the assembled battery module 11 has a central area of one of the opposed major surfaces thereof on which pressure, as produced by the coil springs 101, is exerted. In other words, the coil springs 101 are disposed on the central area of the upper surface of the assembled battery module 11. Such a central area will also be referred to as a pressure-exerted area below. The pressure-exerted area occupies the center of gravity of the assembled battery module 11 in a planar view thereof. The pressing mechanism has the four coil springs 11 arranged in a 2-by-2 matrix. The control board 12 is laid to overlap the center of gravity of the assembled battery module 11 in the vertical direction (i.e., the thickness-wise direction of the battery unit 10). Specifically, the hole 101 is formed in an area of the control circuit board 12 which covers or overlap the center of gravity of the assembled battery module 11 in the thickness-wise direction of the battery unit 10 (i.e., a direction in which the pressure, as produced by the coil springs 101, acts on the assembled battery module 11). In other words, the pressing mechanism (i.e., the coil springs 101) is so located as to exert mechanical pressure on the center of gravity of the assembled battery module 11 through the upper surface of the assembled battery module 11.

The rigid plate 87 is, as described above, affixed to the upper surface of the battery assembly 81 of the assembled battery module 11. The coil springs 101 are disposed on the rigid plate 87. The cover 15, as described already, has formed on the lower surface thereof the spring holder 35 which retains the ends of the coil springs 101. Specifically, the spring holder 35 has the chambers 35a in which the coil springs 101 are put, respectively, so that the coil springs 101 are located in place on the pressure-exerted area of the assembled battery module 11.

The cover 15 is joined to the base 14 and compresses the lengths of the coil springs 101 to produce mechanical pressure. The mechanical pressure is exerted on the assembled battery module 11. Use of the four coil springs 101 results in an increase in area of the assembled battery module 11 (i.e., the pressure-exerted area) on which the mechanical pressure, as produced by the coil springs 101 acts. Use of the rigid plate 87 achieves uniform distribution of the mechanical pressure over the upper surface of the battery assembly 81 of the assembled battery module 11.

### Electrical Structure of Vehicle Power Supply System

The electrical structure of the in-vehicle power supply system will be described below with reference to FIG. 23. The assembled battery module 11 of the battery unit 10 is, as described above, equipped with the four cells 83 connected in series. Each of the cells 83 is connected at the positive and negative terminals thereof to a controller 122 through electric paths 121. The controller 122 is implemented by a CPU (i.e., an arithmetic device) working to perform a give control task to control the charging or discharging operation of the assembled battery module 11. The controller 122 is an electronic part mounted on the control board 12. The bus bars 94 (94a to 94e), as illustrated in FIG. 13, are connected to the positive and negative terminals of the cells 83. The electric paths 121 are provided by the bus bars 94 and the voltage detecting terminals 96.

The battery unit 10 is equipped with connecting terminals 123 and 124 which are coupled together through a wire 125. The assembled battery module 11 is connected to a wire 126 diverging from the wire 125. A switch 127 is disposed in the wire 135. A switch 128 is disposed in the wire 126. Each of the switches 127 and 128 functions as a power control switching device made of, for example, a power MOSFET. The switches 127 and 128 correspond to the power devices P, as illustrated in FIG. 17. The sensor substrate 62 of the water damage sensor 60 is connected to the controller 122.

The power supply system includes a lead-acid storage battery 131 in addition to the battery unit 10. The lead-acid storage battery 131 is coupled to the connecting terminal 123 of the battery unit 10. The battery unit 10 and the lead-acid storage battery 131 are charged by an electric generator (also called an alternator) 132 installed in the vehicle. The vehicle is also equipped with a starter 133 as an electric load which is supplied from electric power from the lead-acid storage battery 131 to start an internal combustion engine mounted in the vehicle. To the battery unit 10, an electric load 134 such as an audio system or a navigation system mounted in the vehicle is coupled through the connecting terminal 134. The battery unit 10 supplies electric power to the electric load 134.

The on/off operation of the switch 127 controlled by the controller 122 will be described briefly. The switch 127 is opened or closed depending upon a state of charge (i.e., an available amount of electric energy) in the assembled battery module 11 and the lead-acid storage battery 131. Specifically, when the state of charge in the assembled battery module 11 is greater than or equal to a given value K1, the controller 122 turns off the switch 127 to disconnect the connecting terminal 123 and the assembled battery module 11. Alternatively, when the state of charge in the assembled battery module 11 has dropped below the given value K1, the controller 122 turn on the switch 127 to connect the connecting terminal 123 and the assembled battery module 11 to charge the assembled battery module 11 using the generator 132.

When it is required to start the engine using the starter 133, and the state of charge in the lead-acid storage battery 131 is greater than or equal to a given value K2, the controller 122 turns off the switch 127 to supply the electric power from the lead-acid storage battery 131 to the starter 133. Alternatively, when the state of charge in the lead-acid storage battery 131 is less than the given value K2, the controller 122 turns on the switch 127 to supply the electric power from the assembled battery module 11 to the starter 133.

The vehicle on which the power supply system is mounted is equipped with an automatic idle stop system (also called an automatic engine start/restart system) which works to automatically stop the engine when an ignition switch is in the on-state. When a given automatic engine stop condition is met, an ECU (i.e., an idle stop ECU) mounted in the vehicle stops the engine automatically. When a given automatic engine restart condition is met after the stop of the engine, the ECU restarts the engine using the starter 133. The automatic engine stop condition is, for example, a condition where an accelerator of the vehicle has been turned off or released, a brake of the vehicle has been turned on or applied, and the speed of the vehicle is less than a given value. The automatic engine restart condition is, for example, a condition where the accelerator has been turned on, and the brake has been turned off.

### Installation of Battery Unit 10

The battery unit 10 is mounted on a floor of the vehicle which defines a passenger compartment. More specifically, the bottom plate 21 of the base 14 is disposed horizontally beneath front seats of the vehicle. The battery unit 10 is in the passenger compartment of the vehicle, so that there is a low possibility that the battery unit 10 is splashed with water or mud as compared with the case where the battery unit 10 is mounted inside an engine compartment of the vehicle. The battery unit 10 may alternatively be placed other than beneath the front seats, for example, in a space between rear seats and a rear luggage compartment.

The above described embodiment offers the following advantages.

The battery (i.e., the assembled battery module 11) of the above embodiment, as described already, includes a stack of the laminated-type cells 83 each of which is equipped with the electrode tabs 84 and 85 serving as the positive terminal and the negative terminal, respectively. Each of the electrode tabs 84 and 85 has a base end leading to a body (i.e., the cell body 83) of a corresponding one of the cells 83. The electrode tabs 84 and 85 of all the cells 83 are, as described above, classified into the first electrode tabs T1 and the second electrode tabs T2. The first electrode tabs T1 are the electrode tabs 86 of every adjacent two of the cells 83. The first electrode tabs T1 have portions which are laid on one another and joined to the bus bars 94, respectively. The second electrode tabs T2 are the electrode tabs 84 and 85 of the cells. Each of the second electrode tabs T2 has a portion joined to one of the bus bars 94 without being connected to any of the electrode tabs 94. Each of the first and second electrode tabs T1 and T2 is, as described above, made of a flat plate member with major surfaces opposed to one another in the thickness-wise direction thereof. Each of the first and second electrode tabs T1 and T2 has a bent portion (i.e., the first bent portion 86 or the second bent portion 87) which is shaped to protrude in at least one of opposite directions traversing the opposed major surfaces thereof. Specifically, each of the first bent portions 86, as illustrated in FIG. 17, extends or protrudes in either one of the opposite directions perpendicular to the thickness of the cell 83 (i.e., the stacked direction), but may be shaped to have a plurality of sections protruding in different directions. One example of such geometry of the first bent portions 86 will be described later with reference to FIG. 26. Similarly, each of the second bent portions 87 extends or protrudes in either one of the opposite directions perpendicular to the thickness of the cell 83 (i.e., the stacked direction), but may be shaped to have a plurality of sections protruding in different directions. One example of such geometry of the second bent portions 87 will be described later with reference to FIG. 26.

The bent portion 86 or 87 of each of the first and second electrode tabs T1 and T2 is preferably oriented in a direction in which a mechanical stress which arises from oscillation of or thermal shock on the battery (i.e., the assembled battery module 11) and acts on the first and second electrode tabs T1 and T2 is maximized. Such a mechanical stress usually occurs in the case where the assembled battery module 11 is mounted in an automotive vehicle. The bent portions 86 and 87, therefore, function as a stress absorber to minimize the stress acting on the first and second electrode tabs T1 and T2.

The direction in which the mechanical stress is maximized coincides with, for example, the stacked direction in which the cells 83 are stacked in the case were the assembled battery module 11 is mounted in the vehicle with the stacked direction being oriented parallel to the vertical direction of the vehicle. Each of the first and second electrode tabs T1 and T2 is shaped to include a first portion (i.e., the vertical portion 800 in FIG. 17) extending in the stacked direction and a second portion (i.e., the lateral portion 700) extending in a direction perpendicular to the stacked direction. This geometry enhances the efficiency in absorbing the stress acting on the first and second electrode tabs T1 and T2.

The direction in which the mechanical stress is maximized coincides with, for example, a direction perpendicular to the stacked direction in the case where the assembled battery module 11 is mounted in the vehicle with the stacked direction being oriented parallel to the lateral direction of the vehicle. In this case, each of the first and second electrode tabs T1 and T2 is shaped to include a first portion (i.e., the vertical portion 800 in FIG. 26) extending in the stacked direction and a second portion (i.e., the lateral portion 700 in FIG. 26) extending in a direction perpendicular to the stacked direction. This geometry enhances the efficiency in absorbing the stress acting on the first and second electrode tabs T1 and T2.

The first bent portion 86 of each of the first electrode tabs T1, as described above, continues from the base end of the first electrode tab T1 and approaches close to another of the adjacent two cells 83. The first bent portion lies between the base end and the joint of the first electrode tab T1 to the bus bar 94. Similarly, the second bent portion 87 of each of the second electrode tabs T2 continues from the base end of the second electrode tab T2 and lies between the base end and the joint of the second electrode tab T2 to the bus bar 94.

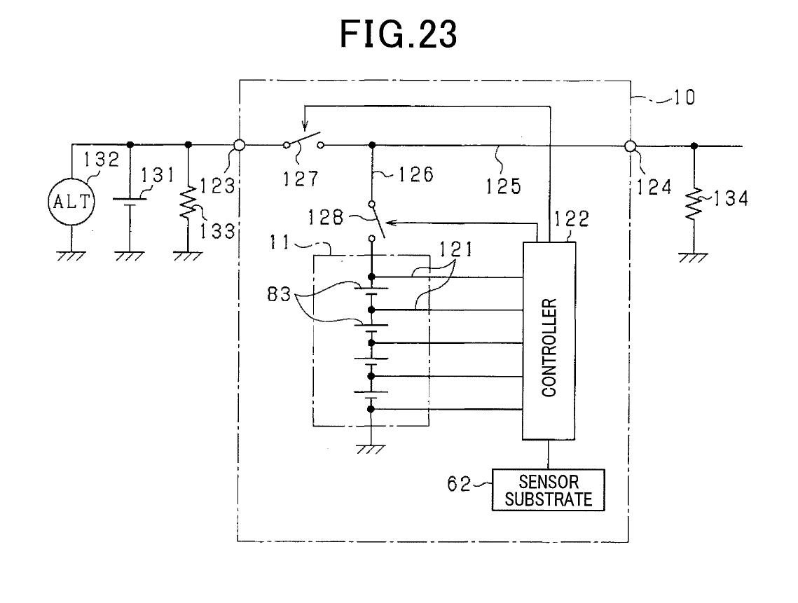

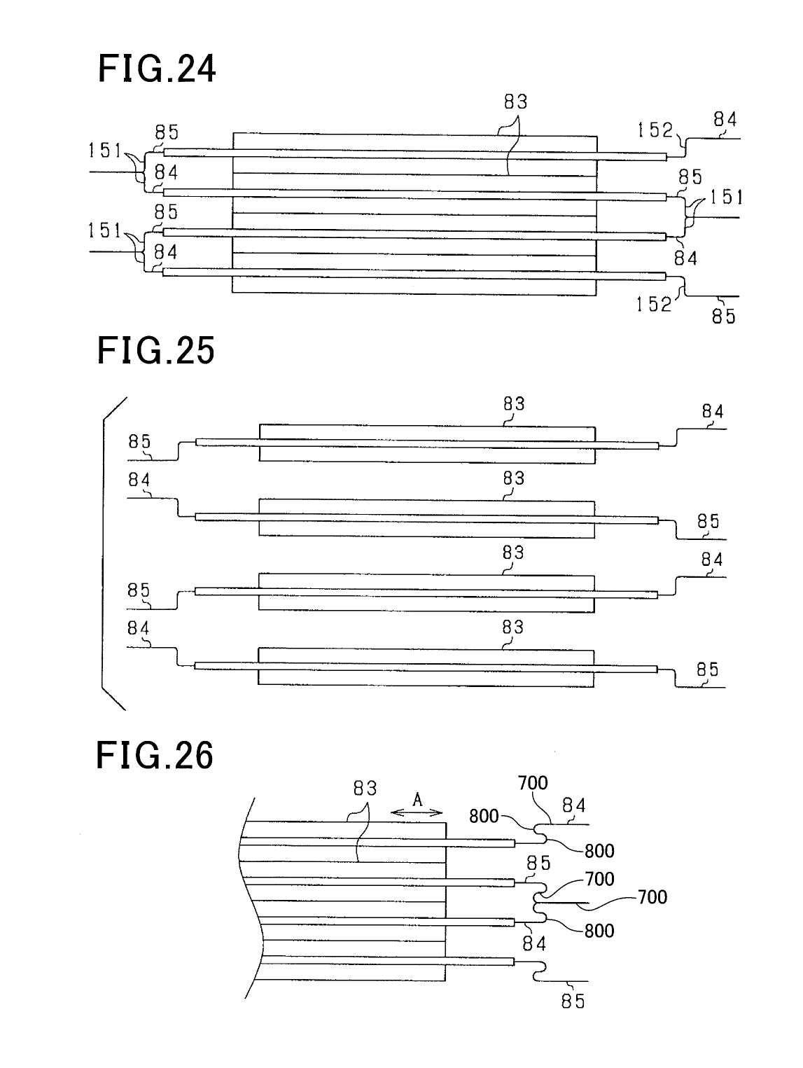

The first bent portions 86 of the first electrode tabs T1 of adjacent two of the cells 83 are, as can be seen in, for example, FIGS. 17 and 18, of the same configuration and oriented in opposite directions (e.g., opposite directions perpendicular to the stacked direction). The second bent portions 87 may be, as will be described later in detail with reference to FIGS. 24, 25, and 26, identical in shape with the first bent portions.

Two of the electrode tabs 84 and 85 which are used as the positive and negative terminals of at least one of the cells 83 have the bent portions 86 and/or 87 protruding in opposite directions parallel to the stacked direction. For instance, such a layout of the electrode tabs 84 and 85 applies to the cells 83 except the lowermost cell 83 in FIG. 17.

The bent portions 86 of the first electrode tabs T1 may be of a crank shape. The bent portions 87 the second electrode tabs T2 may be of a U-shape.

The first bent portions 86 of the first electrode tabs T1 of adjacent two of the cells 83 may be, as illustrated in FIG. 18, oriented in a mirror image with respect to a center line (i.e. a horizontal center line in FIG. 18) extending intermediate between lengths of the first electrode tabs T1.

The bent portions 86 and 87 of the electrode tabs 84 and 85, as already described, serve as vibration absorbers to absorb the oscillations transmitted to the electrode tabs 84 and 85 when subjected to the ultrasonic welding in the ultrasonic welding machine 140, thereby eliminating undesirable stress acting on the electrode tabs 84 and 85.

The assembled battery module 11 has the battery assembly 81 and the battery holder 82 secured firmly in the storage case 13. The electrode tabs 84 and 85 of each of the cells 83 are welded to the bus bars 94. This type of assembled battery module usually encounters the drawback in that the oscillation of the storage case 13 results in stress exerted on the welds of the electrode tabs 84 and 85 to the bus bars 94, which may lead to breakage of the welds. In order to avoid this problem, the electrode tabs 84 and 85 are designed to have the bent portions 86 and 87 functioning as stress absorber to minimize the stress acting on the welds. This ensures the stability in joining of the electrode tabs 84 and 85 to the bus bars 94 and develops substantially the same degree of resistance of the electrode tabs 84 and 85 to the oscillation.

If some of the electrode tabs 84 and 85 are designed to have the bent portions 86 and 87, while the other electrode tabs 84 and 85 are formed not to have the bent portions 86, and 87, it may result in physical interference of the tips of the electrode tabs 84 and 85 with some part of the ultrasonic welding machine 140 during the welding operation or with each other within the storage case 13 depending upon the configuration of the storage case 13. The bent portions 86 and 87 also serve to facilitate the ease with which the tips of the electrode tabs 84 and 85 on either side of the battery assembly 81 are arrayed in alignment with the stacked direction (i.e., the thickness-wise direction) I of the battery assembly 81. This layout of the tips of the electrode tabs 84 and 85 eliminates the above problems and ensures the stability in joining of the electrode tabs 84 and 85 and the bus bars 94.

The formation of the bent portions 86 and 87, as described above, eliminates the need for adjusting lengths of materials of the electrode tabs 84 and 85 or sizes of the cells 83 to achieve the alignment of the tips of the electrode tabs 84 and 85 in advance. Specifically, the bent portions 86 and 87 are so geometrically shaped as to make all the electrode tabs 84 and 85 have the same length that is a linear distance between the base end of each of the electrode tabs 84 and 85 leading to the cell 83 and the tip end thereof, thereby avoiding the interference of the tips of the electrode tabs 84 and 85 with any part of the ultrasonic welding machine 140 during the welding operation.

The electrode tabs 84 and 85 are substantially identical with each other in length of material thereof (i.e., length of the electrode tabs 84 and 85 before being bent to form the bent portions 86 and 87), thus resulting in uniformity of effects of heat, as generated at the welds during the ultrasonic welding operation, on the cells 83. The formation of the bent portions 86 and 87 results in an increased length of thermally conductive paths (i.e. overall lengths of the electrode tabs 84 and 85), thereby minimizing a variation in adverse thermal effect on the cells 83 during the welding operation of the ultrasonic welding machine 140.

The bent portions 86 and 87 all extend in the same plane, in other words, are all oriented in the same direction, that is, the stacked direction of the cells 83 which is a direction in which the stress which arises from the oscillation of the battery unit 10 and acts on the electrode tabs 84 and 85 is maximized, thus resulting in enhanced effectiveness in absorbing the oscillation of the battery unit 10 when mounted in the automotive vehicle. The bent portions 86 and 87 also work to absorb deformation (i.e., expansion or contraction) of the cells 83 when subjected to heat.

The bus bars 94 are located substantially at the same distance from either side of the cell body 83a. The electrode tabs 84 and 85 extending from each side of the cell body 83a are arrayed to have the tips aligned with each other in the stacked direction of the cells 83. In other words, portions of the electrode tabs 84 and 85 which extend outwardly from the welds thereof have tips located substantially in the same position in the direction in which the electrode tabs 84 and 85 extend, thereby avoiding the physical interference of the tips with the ultrasonic welding machine 140 or the inner wall of the storage case 13.

The joining of the positive electrode tab 84 and the bus bar 94 is, as described above, achieved by laying the bus bar 94 which is higher in hardness than the positive electrode tab 84 on the positive electrode tab 84 and welding them together. Specifically, the bus bar 94 functions as a reinforcement or protective plate to minimize the physical damage to the positive electrode tab 84 during the welding operation, thus ensuring the stability in joining of the positive electrode tab 84 and the bus bar 94.

The assembled battery module 11 uses the bus bars 94 for input or output of electric power into or from the battery assembly 81 or measurement of voltage developed at the cells 83. The bus bars 94 are, as described above, formed to be higher in hardness than the positive electrode tab 84 and used as the reinforcement or protector in ultrasonic welding the bus bars 94 to the positive electrode tabs 84, thus providing the stability of the weld.

Each of the positive electrode tabs 84 is, as described above, made of aluminum, while each of the negative electrode tabs 85 is made of copper. The positive electrode tabs 84 are, thus, lower in hardness than the negative electrode tabs 85. The welding of the positive electrode tab 84, the negative electrode tab 85, and the bus bar 94 is achieved by sandwiching the positive electrode tab 84 between the negative electrode tab 85 and the bus bar 94 which are higher in hardness than the positive electrode tab 84, thereby eliminating the need for additional reinforcement or protector to avoid the breakage of the positive electrode tab 84 during the welding operation.

The battery holder 82, as described above, serves as a bus bar holder to have the bus bars 94 arrayed in the stacked direction of the cells 82 on either side of the assembled battery module 11. The bus bars 94 are, as described above, used as the reinforcement in the ultrasonic welding operation. The bus bars 94 are cantilevered by the battery holder 82 and welded at tip portions thereof to the positive electrode tabs 84 or the negative electrode tabs 85. The bus bars 94 are, as described above, firmly retained by the battery holder 82. The battery holder 82 is so designed that when it is attached to the battery assembly 81, the positive electrode tabs 84 and the negative electrode tabs 85 will be located closer to the bus bars 94, thus facilitating the ease with which the positive electrode tab 84 and/or the negative electrode tab 85 is welded to each of the bus bars 94.

The connector 93 (i.e., the connecting bars 98) of the battery holder 82 is inserted into an air gap between the laminated films of vertically adjacent two of the cells 83, so that the connector 93 does not protrude outside the battery assembly 81 after the battery holder 82 is attached to the battery assembly 81, thereby avoiding an increase in overall size of the assembled battery module 11.

The joining of all the bus bars 94 to the positive electrode tabs 84 and/or the negative electrode tabs 85 is made by placing the bus bars 94 just beneath the positive electrode tabs 84 from only one of opposite directions in which the cells 83 are stacked (i.e., a downward direction in the above embodiment) and welding them. Such arrangement of the bus bars 94 is achieved fully only by attaching the battery holder 82 to the battery assembly 81. This is very useful when the positive electrode tab 84 which is lower in hardness needs to be interposed between the negative electrode tab 85 and the bus bar 94 and minimizes an error in stacking the positive electrode tab 84, the negative electrode tab 85, and the bus bar 94 vertically.

Modifications of the above embodiment will be described below.

Each of the electrode tabs 84 and 85 may be designed to have a shape, as illustrated in FIG. 24. Specifically, the electrode tabs 84 and 85 have bent portions 151 and 152 which are all identical in shape with each other. More specifically, every two of the electrode tabs 84 and 85 which are welded together (i.e., the first electrode tabs T1) have the first bent portions 151 which are of the same configuration and oriented in a mirror image with respect to the center line extending intermediate between the lengths of the first electrode tabs T1. Two of the electrode tabs 84 and 85 which are used as the battery positive terminal and the battery negative terminal of the battery assembly 81 (i.e., the second electrode tabs T2) have the second bent portions 152 which are identical in shape with the first bent portion 151 and, as can be seen in FIG. 24, oriented in a mirror image with respect to the center line extending intermediate between the lengths of the second electrode tabs T2. Each of the cells 83 has a pair of the positive electrode tab 84 and the negative electrode tab 85 which are, as clearly illustrated in the drawing, bent in opposite directions. The cells 83 are, therefore, as illustrated in FIG. 25, stacked with the positive electrode tab 84 and the negative electrode tab 85 of each of the cells 83 being bent or oriented in opposite directions parallel to the thickness of the stack of the cells 83 (i.e., upward and downward directions, as viewed in FIG. 25) in order to facilitate the series-connection of the electrode tabs 84 and 85.

The bent portions 151 and 152 of the electrode tabs 84 and 85 are, as described above, all identical in shape with each other, thus permitting the same die to be used to form the bent portions 151 and 152, which improves the bending efficiency, and also permitting materials of the electrode tabs 84 and 85 to have the same length, and the electrode tabs 84 and 85 after they are shaped to have the same length between the base end leading to the cell body 83a and the weld thereof.

The same configuration of the bent portions 151 and 152 allows all the cells 83 to be produced in the same way, thus improving the forming activities of the cells 83.

The second electrode tabs T2 (i.e., uppermost and lowermost ones of the electrode tabs 84 and 85 on the right side in FIG. 24 which are used as the battery positive and negative terminals of the battery assembly 81) may be oriented oppositely to the ones illustrated in FIG. 24. Specifically, the electrode tab 84 that is used as the battery positive terminal of the battery assembly 81 is bent downward in FIG. 24, while the electrode tab 85 that is used as the battery negative terminal of the battery assembly 81 is bent upward in FIG. 24.

Each of the electrode tabs 84 and 85 may alternatively be shaped to have at least two waves or protrusions: one being oriented upward, and the other being oriented downward, that it, in opposite directions traversing perpendicular to a plane of the electrode tabs 84 and 85. Such protrusions may be knurled, for example, of a U-shape or polygonal shape. Alternatively, each of the electrode tabs 84 and 85, as illustrated in FIG. 26, may be bent several times (two times in the drawing) in a direction perpendicular to the length thereof (i.e., the vertical direction in the drawing) so as to have a tip portion extending horizontally (i.e., a direction perpendicular to the stacked direction of the cells 83). Usually, each of the cells 83 thermally expands or contracts in a direction A in FIG. 26 that is identical with the direction in which the electrode tabs 84 and 85 extend. The thermal expansion or contraction will create mechanical stress acting on the electrode tabs 84 and 85. The bends of the electrode tabs 84 and 85 shaped, like in FIG. 26, permit the electrode tabs 84 and 85 to move or elastically deform in the direction A to absorb the stress.

The joining of the electrode tabs 84 and 85 and the bus bar 94 of the battery assembly 81 of the assembled battery module 1 is achieved in the above embodiment by placing the bus bar 94 at the bottom of a stack of the electrode tabs 84 and 85 and the bus bar 94 (i.e. closest to the anvil 141 in FIG. 20(a)) and welding them. Such a layout may be changed. For instance, the joining may be accomplished by laying the bus bar 94 at the top of the stack (i.e., closes to the horn 142 in FIG. 20(a)), placing the electrode tabs 84 and 85 close to the anvil 141, and welding them. In such a welding operation, the positive electrode tab 84 is, unlike in FIG. 20(a), arranged above the negative electrode tab 85 close to the bus bar 94. In either case, the joining is always made by sandwiching the positive electrode tab 84 that is lower in hardness between the bus bar 94 and the negative electrode tab 85 which are higher in hardness.

The positive electrode tab 84 and the negative electrode tab 85 are, as described above, made of materials different from each other. Specifically, the positive electrode tab 84 is made of aluminum, while the negative electrode tab 85 is made of copper. The positive and negative electrode tabs 84 and 85, however, may alternatively be made from the same material. For instance, the positive and negative electrode tabs 84 and 85 may be made from aluminum. In this case, the joining of the positive and negative electrode tabs 84 and 85 and the bus bar 94 is preferably achieved by placing the bus bar 94 on one of opposed surfaces of a stack of the positive and negative electrode tabs 84 and 85, putting a reinforcement like the contact plate 99 on the other surface of the stack, and welding them through the ultrasonic welding machine 140.

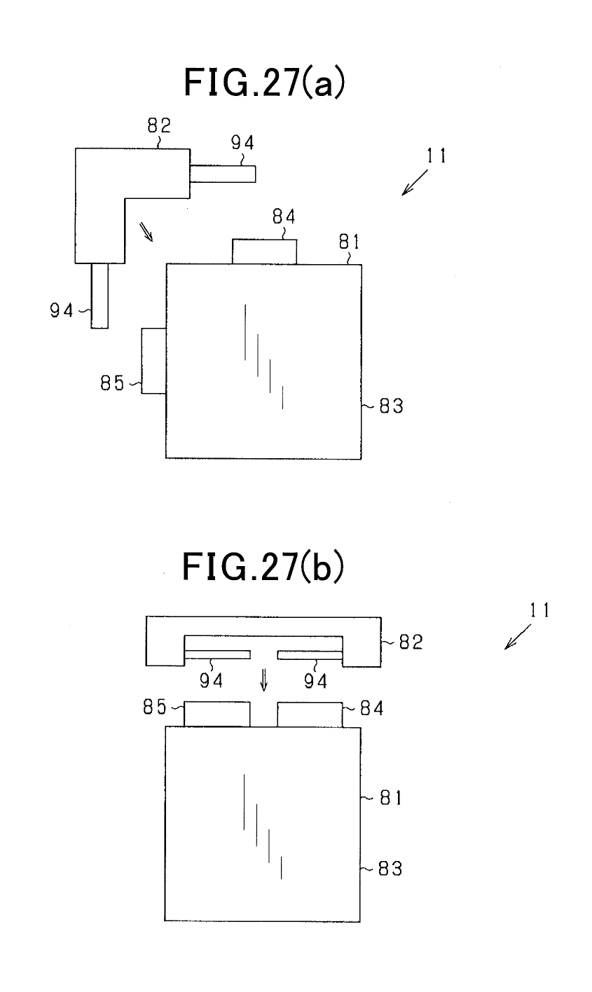

Each of the cells 83, as described above, the positive electrode 84 and the negative electrode 85 extending outwardly from diametrically-opposed two of the four sides thereof, but may alternatively designed to have the positive and negative electrodes 84 and 85 arranged on adjacent two sides thereof. In this case, the battery holder 82 is shaped, as illustrated, for example, in FIG. 27(a).

In the example of FIG. 27(a), the positive electrode tab 84 and the negative electrode tab 85 are so formed as to extend from adjacent two (i.e., mutually orthogonal two) of the four sides of the cell 83. The battery holder 82 is equipped with two sets of the bus bars 94 each set extending in parallel to one of the adjacent two of the four sides of the cell 83. In the example of FIG. 27(b), each of the cells 83 is designed to have the positive electrode tab 84 and the negative electrode tab 85 arranged next to each other on the same one of the four sides thereof. The battery holder 82 is equipped with two sets of the bus bars 94 all extending substantially parallel to the one of the four sides of the cells 83 on which the positive and negative electrode tabs 84 and 85 are arrayed.

In each of the examples of FIGS. 27(a) and 27(b), the electrical series-connection of the cells 83 of the battery assembly 81 is achieved by laying the positive electrode tab 84 of one of every adjacent two of the cells 83 on the negative electrode tab 85 of the other cell 83 and welding them together expect the positive and negative electrode tabs 84 and 85 which are used as the battery positive and negative terminals of the battery assembly 81. The bus bars 94 are, like in the above embodiment, put on the positive electrode tab 84, the negative electrode tab 85, and stacks of the positive electrode tab 84 and the negative electrode tab 85 from the same direction (i.e., one of opposite directions extending parallel to the thickness of the cells 83) and welded together. In other words, each of the electrode tabs 84 and 85 of the cells 83 stacked in the battery assembly 81 has one of major opposed surfaces which faces in the same one of opposite directions in which the cells 83 are stacked. Other arrangements in the examples of FIGS. 27(a) and 27(b) are the same as those in the above embodiment, and explanation thereof in detail is omitted here.

The battery holder 82, as described above in FIG. 13, has the first retainer 91 and the second retainer 92 formed integrally, but however, the first retainer 91 and the second retainer 92 may alternatively be formed to be separate from each other. Specifically, the first retainer 91 and the second retainer 92 are attached to the battery assembly 81 independently from each other.

The battery holder 82 have the bus bars 94 all cantilevered by the first and second retainers 91 and 92, but however, may be designed to double-support each of the bus bars 94 at two points of attachment to one of the first and second retainers 91 and 92.

The positive and negative electrode tabs 84 and 85 of the cells 83 and/or the bus bars 94 are, as described above, ultrasonic-welded together, but may be joined in another way. For instance, they may be joined at a lower frequency such as several hundred Hertz using vibration welding techniques or thermal welding techniques utilizing thermal energy produced by a heat source.

The control board 12 is mounted within the storage case 13, but may be disposed outside the storage case 13.

The base 14 is, as clearly illustrated in FIG. 2, located vertically beneath the cover 15. The battery unit 10 is installed transversely. The base 14 and the cover 15 may alternatively be arranged adjacent each other horizontally, while the battery unit 10 is placed vertically.

The storage case 13 is, as described above, made up of the base 14, the cover 15, and the intermediate case 16, but may be formed by only the base 14 and the cover 15. For instance, the upright wall 22 of the base 14 is designed to have an increased height to provide a required space within the storage case 13 in the height direction thereof. Alternatively, the cover 15 may be designed to have a vertical side wall to provide a required overall height of the storage case 13.

The battery unit 10 is, as described above, mounted beneath the seats in the passenger compartment of the vehicle, however, may be disposed inside a dashboard or an engine compartment of the vehicle.

Each of the cells 83 is, as described above, a lithium-ion storage cell, but may be implemented by another type of secondary cell such as a nickel-cadmium storage cell or a nickel-hydrogen storage cell(s).

The battery unit 10 may be used with hybrid vehicles equipped with an internal combustion engine and an electric motor for driving road wheels or an electric vehicle equipped with only the electric motor as a drive source.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments which can be embodied without departing from the principle of the invention as set forth in the appended claims.

What is claimed is:

1. A battery unit comprising:
a battery which includes a stack of a plurality of laminated-type cells each of which is equipped with electrode tabs serving as a positive terminal and a negative terminal, respectively, each of the electrode tabs having a base end leading to a body of a corresponding one of the cells;
a bus bar holder equipped with a plurality of bus bars joined to the electrode tabs of the cells;
a storage casing in which the battery and the bus bar holder are mounted in the storage casing;
first electrode tabs that are the electrode tabs of every adjacent two of the cells, the first electrode tabs having portions which are laid on one another and joined to the bus bars, respectively; and
second electrode tabs that are the electrode tabs of the cells, each of the second electrode tabs having a portion joined to one of the bus bars without being connected to any of the electrode tabs,
wherein each of the first and second electrode tabs includes opposed major surfaces and has a bent portion which is shaped to protrude in at least one of opposite directions traversing the opposed major surfaces and is located between the base end and a joint to the bus bar.

2. A battery unit as set forth in claim 1, wherein the bent portion of each of the first and second electrode tabs is oriented in a direction in which a mechanical stress which arises from oscillation of or thermal shock on the battery and acts on the first and second electrode tabs is maximized.

3. A battery unit as set forth in claim 2, wherein the direction in which the mechanical stress is maximized is a stacked direction that is a direction in which the laminated-type cells are stacked or a direction perpendicular to the stacked direction, and wherein each of the first and second electrode tabs includes a first portion extending in the stacked direction and a second portion extending in the direction perpendicular to the stacked direction.

4. A battery unit as set forth in claim 1, wherein each of the first electrode tabs includes, as the bent portion, a first bent portion which continues from the base end of the first electrode tab and approaches close to another of the adjacent two cells, the first bent portion lying between the base end and the joint of the first electrode tab, and wherein each of the second electrode tabs includes, as the bent portion, a second bent portion which continues from the base end of the second electrode tab and lies between the base end and the joint of the second electrode tab.

5. A battery unit as set forth in claim 4, wherein the first bent portions of the first electrode tabs of adjacent two of the cells are of the same configuration and oriented in opposite directions, and wherein the second bent portions are identical in shape with the first bent portions.

6. A battery unit as set forth in claim 5, wherein two of the electrode tabs which are used as the positive and negative terminals of at least one of the cells have the bent portions protruding in opposite directions parallel to a direction in which the cells are stacked.

7. A battery unit as set forth in claim 1, wherein the bent portions of the first electrode tabs are of a crank shape, and wherein the bent portions of the second electrode tabs are of a U-shape.

8. A battery unit as set forth in claim 5, wherein the first bent portions of the first electrode tabs of adjacent two of the cells are oriented in a mirror image with respect to a center line extending intermediate between lengths of the first electrode tabs.
